(19) United States
(12) Patent Application Publication
(10) Pub. No.: US 2015/0113012 A1
(43) Pub. Date: Apr. 23, 2015

(54) SYSTEMS, DEVICES AND METHODS FOR FACILITATING ELECTRONIC COMMUNICATION UTILIZING VEHICLE LICENSE PLATE NUMBERS

(71) Applicant: Cynthia J. Silver, Renton, WA (US)

(72) Inventor: Cynthia J. Silver, Renton, WA (US)

(21) Appl. No.: 14/059,392

(22) Filed: Oct. 21, 2013

(51) Int. Cl. H04L 12/58; H04W 68/00; G06F 17/30

(52) U.S. Cl. CPC H04L 51/38; G06F 17/30424; H04W 68/00
USPC 707/758; 709/217; 709/206

(57) ABSTRACT

Using the license plate of a vehicle, a system posts or sends messages or other information associated with the license plate number such that other drivers and/or other users can respond to the messages if they choose to do so. This can be accomplished anonymously through an online system on which registered users can publicly post and/or privately send comments, messages, compliments, warnings and/or other information associated with the license plate number of the vehicle. The driver of the vehicle and/or other users may then access the online system and search the database of messages using their license plate number and reply publicly, privately and/or anonymously to the registered user that had posted the information associated with the license plate number.

### BRIEF SUMMARY

It often occurs that a driver would like to communicate with another driver, whether be it to express their opinion about the other driver's driving, the other driver's car, or the other driver in general. Using the license plate of the other driver, one is able to post or send messages or other information associated with that license plate number such that the other driver and/or other users can respond to the messages if they choose to do so. This can be accomplished anonymously through an online system on which registered users can publicly post and/or privately send comments, messages, compliments, warnings and/or other information associated with the license plate number of the vehicle of the other driver. The other driver may then access the online system and search the database of messages using their license plate number and reply publicly, privately and/or anonymously to the registered user that had posted the information associated with the license plate number.

The other driver may also select to receive automated notices when any messages are posted or sent associated with the other driver's or other selected license plate numbers. The registered users may also select to send messages associated with a particular license plate number only to other registered users who have chosen to receive messages associated with the particular license plate number. Users may also select to opt out of the system posting public messages and/or sending private messages associated with their license plate number. In this instance, the user may be required to provide proof that they are the registered owner of the vehicle having the license plate number for which this “opt out” option is being selected. If desired, the users may also exchange personal contact information with each other.

A method performed by at least one server machine for facilitating electronic communication utilizing vehicle license plate numbers may be summarized as including electronically authenticating, by at least one authentication component of the at least one server machine for facilitating electronic communication utilizing vehicle license plate numbers, a registered user of a system for facilitating electronic communication utilizing vehicle license plate numbers, wherein the system for facilitating electronic communication utilizing vehicle license plate numbers is electronically accessible by the authentication component in order for the authentication component to perform the authentication electronically; electronically receiving, by at least one communications component of the at least one server machine for facilitating electronic communication utilizing vehicle license plate numbers, information electronically authenticated to be from the registered user, the information including and associated with a vehicle license plate number of a vehicle that is not a vehicle of the registered user; electronically associating, by at least one association component of the at least one server machine for facilitating electronic communication utilizing vehicle license plate numbers, the information including and associated with the vehicle license plate number with an electronic account of the registered user, the electronic account of the registered user electronically accessible by the at least one server machine for facilitating electronic communication utilizing vehicle license plate numbers in order for the at least one server machine for facilitating electronic communication utilizing vehicle license plate numbers to perform the associating electronically; electronically storing, by at least one storage component of the system for facilitating electronic communication utilizing vehicle license plate numbers accessible by the at least one server machine for facilitating electronic communication utilizing vehicle license plate numbers, the information electronically authenticated to be from the registered user and the association between the information including and associated with the vehicle license plate number and the electronic account of the registered user; and based on the association between the information including and associated with the vehicle license plate number and the electronic account of the registered user, the at least one communications component electronically making available to the general public over a computer network the information including and associated with the vehicle license plate number.

The receiving, by at least one communications component of the at least one server machine for facilitating electronic communication utilizing vehicle license plate numbers, information electronically authenticated to be from the registered user may include receiving the information electronically authenticated to be from the registered user from a remote machine of the registered user. The information electronically authenticated to be from the registered user may include information regarding driving behavior of a driver of the vehicle that is not a vehicle of the registered user. The information electronically authenticated to be from the registered user may include information regarding a complaint regarding driving behavior of a driver of the vehicle that is not a vehicle of the registered user. The information electronically authenticated to be from the registered user may include information regarding a compliment regarding a driver of the vehicle that is not a vehicle of the registered user. The information electronically authenticated to be from the registered user may include a message from the registered user to a driver of the vehicle that is not a vehicle of the registered user, the message associated with and identifiable by the vehicle license plate number.

The method performed by at least one server machine for facilitating electronic communication utilizing vehicle license plate numbers may further include sending, by at least one communications component of the at least one server machine for facilitating electronic communication utilizing vehicle license plate numbers, the information to a machine of a user associated with the vehicle license plate number based on the vehicle license plate number.

The method performed by at least one server machine for facilitating electronic communication utilizing vehicle license plate numbers may further include, before the sending, electronically identifying via the license plate number, by at least one identification component of the at least one server machine for facilitating electronic communication utilizing vehicle license plate numbers, the user associated with the vehicle license plate number.

The user associated with the vehicle license plate number may be one of a plurality of registered users of the system for facilitating electronic communication utilizing vehicle license plate numbers. The identifying may include electronically searching, by at least one database searching component of the at least one server machine for facilitating electronic communication utilizing vehicle license plate numbers, a database of vehicle license plate numbers to find the vehicle license plate number of the user associated with the vehicle license plate number, the database of vehicle license plate numbers accessible by the searching component in order for the searching component to perform the searching of the database of vehicle license plate numbers. The database of vehicle license plate numbers may include: an electronically stored relationship between an account of the registered user and the license plate number of the registered user; and a one to many relationship between the account of the registered user and license plate numbers of vehicles that are not vehicles of the registered user based on information electronically authenticated to be from one or more registered users.

The method performed by at least one server machine for facilitating electronic communication utilizing vehicle license plate numbers may further include electronically receiving, by at least one communications component of the at least one server machine for facilitating electronic communication utilizing vehicle license plate numbers, information from a user that is a registered owner of the vehicle having the license plate number that is not the vehicle of the registered user; and associating the registered owner of the vehicle that is not the vehicle of the registered user with a license plate number of the registered owner of the vehicle.

The method performed by at least one server machine for facilitating electronic communication utilizing vehicle license plate numbers may further include, based on the electronically receiving the information from a user that is the registered owner of the vehicle having the license plate number that is not the vehicle of the registered user, identifying the registered user, by the at least one identification component of the at least one server machine for facilitating electronic communication utilizing vehicle license plate numbers, based on the association between the information including and associated with the vehicle license plate number and the electronic account of the registered user; and sending a notification to the registered user, by the at least one communications component of the at least one server machine for facilitating electronic communication utilizing vehicle license plate numbers, that the user who is the registered owner of the vehicle having the license plate number has responded with a response to the electronically making available to the general public the information including and associated with the vehicle license plate number.

The method performed by at least one server machine for facilitating electronic communication utilizing vehicle license plate numbers may further include, based on the electronically received information from the user that is the registered owner of the vehicle having the license plate number that is not the vehicle of the registered user, registering on the system for facilitating electronic communication utilizing vehicle license plate numbers, by a registration component of the at least one server machine for facilitating electronic communication utilizing vehicle license plate numbers, the user who is the registered owner of the vehicle having the license plate number, wherein the registering may include: generating, by a registration component of the at least one server machine for facilitating electronic communication utilizing vehicle license plate numbers, a user account for the user that is the registered owner of the vehicle; and associating, by at least one association component of the at least one server machine for facilitating electronic communication utilizing vehicle license plate numbers, the generated user account with the vehicle license plate number.

The method performed by at least one server machine for facilitating electronic communication utilizing vehicle license plate numbers may further include, before the electronically receiving information from the user that is the registered owner of the vehicle having the license plate number that is not the vehicle of the registered user, electronically making available to the general public, by the at least one communications component of the at least one server machine for facilitating electronic communication utilizing vehicle license plate numbers, an electronically generated user interface to respond to the electronically making available to the general public the information including and associated with the vehicle license plate number; and based on the license plate number, associating, by at least one association component of the at least one server machine for facilitating electronic communication utilizing vehicle license plate numbers, the response from the registered owner of the vehicle having the license plate number with the electronically making available to the general public the information including and associated with the vehicle license plate number.

The method performed by at least one server machine for facilitating electronic communication utilizing vehicle license plate numbers may further include, in response to the electronically receiving the information from the user that is the registered owner of the vehicle, searching based on the license plate number in an electronic database, by at least one database searching component of the at least one server machine for facilitating electronic communication utilizing vehicle license plate numbers, to find an account of the registered user of the system for facilitating electronic communication utilizing vehicle license plate numbers that is electronically associated with the information including and associated with the vehicle license plate number made available to the general public; and in response to the searching, communicating based on the license plate number, by at least one communications component of the at least one server machine for facilitating electronic communication utilizing vehicle license plate numbers, at least some of the information from the user that is the registered owner of the vehicle to a machine of the registered user of the system for facilitating electronic communication utilizing vehicle license plate numbers, such that the at least some of the information identifies to the registered user, solely by the vehicle license plate number included in and associated with the information made available to the general public, the user that is the registered owner of the vehicle having the vehicle license plate number.

The information including and associated with the vehicle license plate number that is electronically made available to the general public by the at least one communications component may include one or more of: information regarding a vehicle having the vehicle license plate number, information regarding a driver of a vehicle having the vehicle license plate number, information regarding an owner of a vehicle having the vehicle license plate number, a complaint regarding driving behavior of a driver of a vehicle having the vehicle license plate number, a compliment regarding a driver of the vehicle having the vehicle license plate number, a request to contact a driver of the vehicle having the vehicle license plate number, suspicious activity of a driver of the vehicle having the vehicle license plate number, an equipment failure regarding a vehicle having the vehicle license plate number, an advertisement regarding a vehicle having the vehicle license plate number, contact information regarding a driver of a vehicle having the vehicle license plate number, contact information regarding an owner of a vehicle having the vehicle license plate number, an accident regarding a vehicle having the vehicle license plate number and an emergency regarding the vehicle having the vehicle license plate number.

The electronically receiving, by at least one communications component of the at least one server machine for facilitating electronic communication utilizing vehicle license plate numbers, the information including and associated with a vehicle license plate number of a vehicle that is not a vehicle of the registered user may include electronically receiving the information including and associated with the vehicle license plate number of the vehicle, from one or more of: a mobile device of the registered user of the system for facilitating electronic communication utilizing vehicle license plate numbers, a vehicle of the registered user of the system for facilitating electronic communication utilizing vehicle license plate numbers and a computer of the registered user of the system for facilitating electronic communication utilizing vehicle license plate numbers.

A system for facilitating electronic communication utilizing vehicle license plate numbers may be summarized as including at least one authentication component of at least one server machine that electronically authenticates a registered user of the system for facilitating electronic communication utilizing vehicle license plate numbers; at least one communications component of the at least one server machine that electronically receives information electronically authenticated to be from the registered user, the information including and associated with a vehicle license plate number of a vehicle that is not a vehicle of the registered user of the system; at least one association component of the at least one server machine that electronically associates the information including and associated with the vehicle license plate number with an electronic account of the registered user; at least one storage component accessible by the at least one server machine that electronically stores the information electronically authenticated to be from the registered user and the association between the information including and associated with the vehicle license plate number and the electronic account of the registered user; and at least one communications machine that, based on the association between the information including and associated with the vehicle license plate number and the electronic account of the registered user, makes available to the general public the information including and associated with the vehicle license plate number.

The at least one communications component of the at least one server machine for facilitating electronic communication utilizing vehicle license plate numbers may send, based on the vehicle license plate number, the information to a machine of a user associated with the vehicle license plate number.

The system for facilitating electronic communication utilizing vehicle license plate numbers may further include at least one identification component of the at least one server machine for facilitating electronic communication utilizing vehicle license plate numbers that electronically identifies, via the vehicle license plate number, the user associated with the vehicle license plate number before the at least one communications component of the at least one server machine sends the information to the machine of the user associated with the vehicle license plate number.

At least one non-transitory computer-readable storage medium having computer-executable instructions stored thereon may be summarized as one that, when executed by at least one computer system, causes the at least one computer system to perform: electronically associating information including and associated with a vehicle license plate number with an electronic account of a registered user, wherein the vehicle license plate number is of a vehicle that is not a vehicle of the registered user and wherein the information including and associated with the vehicle license plate number and associated with the electronic account of the registered user is electronically authenticated to be from the registered user; based on the association between the information including and associated with the vehicle license plate number and the electronic account of the registered user, making available to the general public the information including and associated with the vehicle license plate number; receiving information from a user that is not the registered user identifying the user as a registered owner of a vehicle having the vehicle license plate number; and sending the information including and associated with the vehicle license plate number and associated with the electronic account of the registered user to a machine of the registered owner of a vehicle having the vehicle license plate number.

The information including and associated with the vehicle license plate number that is electronically made available to the general public may include one or more of: information regarding a vehicle having the vehicle license plate number, information regarding a driver of a vehicle having the vehicle license plate number, information regarding an owner of a vehicle having the vehicle license plate number, a complaint regarding driving behavior of a driver of a vehicle having the vehicle license plate number, a compliment regarding a driver of the vehicle having the vehicle license plate number, a request to contact a driver of the vehicle having the vehicle license plate number, suspicious activity of a driver of the vehicle having the vehicle license plate number, an equipment failure regarding a vehicle having the vehicle license plate number, an advertisement regarding a vehicle having the vehicle license plate number, contact information regarding a driver of a vehicle having the vehicle license plate number, contact information regarding an owner of a vehicle having the vehicle license plate number, an accident regarding a vehicle having the vehicle license plate number and an emergency regarding the vehicle having the vehicle license plate number.

The information electronically authenticated to be from the registered user may include a message from the registered user to a driver of the vehicle that is not a vehicle of the registered user, the message associated with and identifiable by the vehicle license plate number.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a system diagram of a networked environment, in which systems, devices and methods for facilitating electronic communication utilizing vehicle license plate numbers may be a part, or in which they may be implemented, according to one illustrated embodiment.

FIG. 2 is a schematic diagram of an example computer system of the server machine for facilitating electronic communication utilizing vehicle license plate numbers and/or the user computer of FIG. 1, suitable for implementing systems, devices and methods for facilitating electronic communication utilizing vehicle license plate numbers, according to one illustrated embodiment.

FIG. 3 is a schematic view of one of the mobile devices of FIG. 1, shown in more detail according to one illustrated embodiment, the mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), and a power source.

FIG. 4 is a diagram representing an example database schema for facilitating electronic communication utilizing vehicle license plate numbers, according to one illustrated embodiment.

FIG. 5 is a flow diagram showing a method of facilitating electronic communication utilizing vehicle license plate numbers, according to one illustrated embodiment.

FIG. 6 is a flow diagram showing a method of facilitating electronic communication utilizing vehicle license plate numbers including sending information associated with a vehicle license plate number to a machine of a registered owner of a vehicle, according to another illustrated embodiment.

FIG. 7 is a user interface map showing example architecture for user navigation of a first portion of a user interface for facilitating electronic communication utilizing vehicle license plate numbers.

FIG. 8 is a user interface map showing example architecture for user navigation of a second portion of a user interface for facilitating electronic communication utilizing vehicle license plate numbers.

FIG. 9 is a user interface map showing example architecture for user navigation of a third portion of a user interface for facilitating electronic communication utilizing vehicle license plate numbers.

FIG. 10 is a wireframe representing an example layout of a “Home” user interface portion for facilitating electronic communication utilizing vehicle license plate numbers.

FIG. 11 is a wireframe representing an example layout of a “Create A Post” user interface portion for facilitating electronic communication utilizing vehicle license plate numbers.

FIG. 12 is a wireframe representing an example layout of a “View Posts” user interface portion for facilitating electronic communication utilizing vehicle license plate numbers.

FIG. 13 is a wireframe representing an example layout of a “View Post Detail” user interface portion for facilitating electronic communication utilizing vehicle license plate numbers.

FIG. 14 is a wireframe representing an example layout of a “Respond to Post” user interface portion for facilitating electronic communication utilizing vehicle license plate numbers.

FIG. 15 is a wireframe representing an example layout of a “Register/Login” user interface screen for facilitating electronic communication utilizing vehicle license plate numbers.

FIG. 16 is a wireframe representing an example layout of a “My Account” user interface portion for facilitating electronic communication utilizing vehicle license plate numbers.

FIG. 17 is a wireframe representing an example layout of a “Manage My Posts” user interface portion for facilitating electronic communication utilizing vehicle license plate numbers.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Various embodiments are described herein that provide systems, devices and methods for facilitating electronic communication utilizing vehicle license plate numbers. For example, when a driver of a vehicle sees another driver, they are able to use their mobile device to immediately post comments about or messages to that other driver in an online forum using the license plate number of the other driver to identify the message or comment. If the other driver then visits the online forum (e.g., by accessing it via a web site address via their web browser, a mobile device application and/or other client) the other driver will be able to provide their license plate number via the web site, mobile device application and/or other client and have the system return some or all of the messages and/or comments pertaining to their license plate number. The other driver is also able to respond directly if the driver that had originally provided the comment or message also provided their contact information in the message or comment or otherwise made such contact information available in conjunction with providing the comment or message.

Additionally or alternatively, the other driver may respond indirectly and/or anonymously via the web site, mobile device application and/or other client in instances where the driver who had originally provided the comment or message is a registered user of the system for facilitating electronic communication utilizing vehicle license plate numbers. This is because the system for facilitating electronic communication utilizing vehicle license plate numbers can relay the message(s) between the drivers anonymously (e.g., by using a double-blind email system as part of or in conjunction with the system for facilitating electronic communication utilizing vehicle license plate numbers). If the driver about whom the message or comment is provided is also a registered user of the system for facilitating electronic communication utilizing vehicle license plate numbers and their user account is associated with the license plate number of their vehicle, then when comments or messages are received by the system pertaining to that user's license plate number, the user will be notified and/or the posting or message may be delivered directly to the user whose account is associated with that license plate number (e.g., sent to their user account, via email, via text, via chat message, etc.).

Also, users may input to the system license plate numbers of other users and the system may provide what comments or posts have been made pertaining to the license plate number provided. This may be useful to research people's driving histories and/or abilities, and/or performance such as when employers are considering candidates for jobs that require driving. In some embodiments, the user who provides the post, comment or message about other drivers may select to have the post, comment or message available to the general public or select a level of privacy for the post, comment or message, such that it may be accessible online only by various selected groups, subgroups and/or individuals. These various selected groups, subgroups and/or individuals may be based on groups defined in various other online social media accounts and/or applications of the user, selected individually, and/or modified by the user, etc.

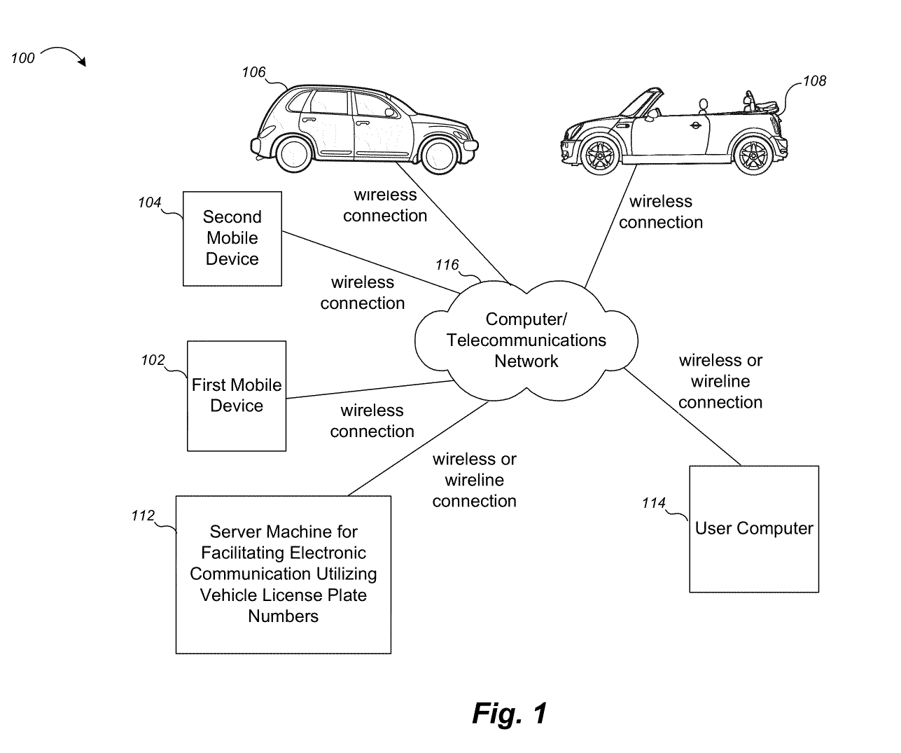

FIG. 1 shows a networked environment 100, in which systems, devices and methods for facilitating electronic communication utilizing vehicle license plate numbers may be a part, or in which they may be implemented, according to one illustrated embodiment.

The networked environment 100 may include a plurality of mobile devices (e.g., first mobile device 102 and second mobile device 104), a plurality of vehicles (e.g., vehicle 1 106 and vehicle 2 108), a server machine for facilitating electronic communication utilizing vehicle license plate numbers 112 and a user computer 114. The first mobile device 102 and second mobile device 104, vehicle 1 106 and vehicle 2 108, server machine for facilitating electronic communication utilizing vehicle license plate numbers 112 and the user computer 114 are all communicatively coupled via a computer/telecommunications network 116. Additional mobile devices, landline telephones, servers, clients, switches, routers and service providers may also be present and included in the network environment, but are not illustrated for clarity of presentation.

The computer/telecommunications network 116 may be any telecommunications network, computer network or combination of telecommunications and computer networks that enables communication between the various devices connected to the network 116 shown in FIG. 1. For example, mobile telecommunications provided by network 116 may include various analog and/or digital mobile telecommunications, for example, including those according to the long-term evolution (LTE), or “4G LTE”, standard for wireless communication of high-speed data for mobile phones and data terminals based on the Global System for Mobile Communications (GSM)/Enhanced Data rates for GSM Evolution (EDGE) and Universal Mobile Telecommunications System (UMTS)/High Speed Packet Access (HSPA) network technologies, and/or other network technologies fulfilling specifications by the International Telecommunication Union.

The mobile devices 102 and 104, vehicle 106, vehicle 108, server machine for facilitating electronic communication utilizing vehicle license plate numbers 112 and user computer 114 may be additionally or optionally linked by one or more other communication links or networks that comprise network 116. For example, a communications network of network 116 may include a local area network that uses wireless fidelity (Wi-Fi) high frequency radio signals to transmit and receive data over distances of a few hundred feet. The local area network may be a wireless local area network (WLAN) based on the Institute of Electric and Electronic Engineers (IEEE) 802.11 standards. However, other wired and wireless communications networks and protocols may be used to link the various devices and systems shown in FIG. 1. Thus, the mobile devices 102 and 104, vehicles 106 and 108, user computer 114 and server machine for facilitating electronic communication utilizing vehicle license plate numbers 112 may have various applicable wireless transmitters and receivers and, in the case of using a Wi-Fi wireless link, may also have the corresponding executable Wi-Fi compatible network communications software that initiates, controls, maintains or manages the wireless link between the mobile devices 102 and 104, vehicles 106 and 108, user computer 114 and the server machine for facilitating electronic communication utilizing vehicle license plate numbers 112, and the various other devices and systems within or connected to network 116 over the Wi-Fi, satellite and/or cellular signal of the network 116.

The network 116 may comprise connections to computing systems such as those in the mobile devices 102 and 104, vehicles 106 and 108, user computer 114 and server machine for facilitating electronic communication utilizing vehicle license plate numbers 112 that provide services to the mobile devices 102 and 104, vehicles 106 and 108, user computer 114 and server machine for facilitating electronic communication utilizing vehicle license plate numbers 112, and may itself represent multiple interconnected networks. For instance, wired and wireless enterprise-wide computer networks, intranets, extranets, and/or the Internet may be included in or comprise a part of network 116. Embodiments may include various types of communication networks including other telecommunications networks, cellular networks, paging networks, and other mobile networks. There may be any variety of computers, switching devices, routers, bridges, firewalls, edge devices, multiplexers, phone lines, cables, telecommunications equipment and other devices within network 116 and/or in the communications paths between the mobile devices 102 and 104, vehicles 106 and 108, user computer 114 and server machine for facilitating electronic communication utilizing vehicle license plate numbers 112. Some or all of such equipment of network 116 may be owned, leased or controlled by various service providers.

In accordance with an aspect of the disclosure, mobile devices 102 and 104, vehicles 106 and 108, user computer 114 and server machine for facilitating electronic communication utilizing vehicle license plate numbers 112 may contain discrete functional program modules that might make use of an application programming interface (API), or other object, software, firmware and/or hardware, to request services of one or more of the other entities within or connected to the network 116, such as mobile devices 102 and 104, vehicles 106 and 108, user computer 114 and server machine for facilitating electronic communication utilizing vehicle license plate numbers 112. For example, communication can be provided over a communications medium, e.g., client and server systems running on any one of the first mobile device 102, second mobile device 104, vehicle 106, vehicle 108, server machine for facilitating electronic communication utilizing vehicle license plate numbers 112 and user computer 114. These client and server systems may be coupled to one another via transmission control protocol/internet protocol (TCP/IP) connection(s) for high-capacity communication. The “client” is a member of a class or group that uses the services of another class or group to which it is not related. In computing, a client is a process, i.e., roughly a set of instructions or tasks, executed by hardware that requests a service provided by another program. Generally, the client process utilizes the requested service without having to “know” any working details about the other program or the service itself. In a client/server architecture, particularly a networked system, a client is usually a computer or device that accesses shared network resources provided by another computer or device, e.g., a server. In the example of FIG. 1 and the mobile devices 102 and 104 may be clients requesting the services of the server machine for facilitating electronic communication utilizing vehicle license plate numbers 112 that is acting as a server. However, any entity in FIG. 1, including mobile devices 102 and 104, vehicles 106 and 108, user computer 114 and/or server machine for facilitating electronic communication utilizing vehicle license plate numbers 112, can be considered a client, a server, or both, depending on the circumstances.

One or more cellular towers and stations may be part of a cellular network that is part of the computer/telecommunications network 116 and may be communicatively linked by one or more communications networks or communication mediums within the computer/telecommunications network 116 (e.g., using a cellular or other wired or wireless signal 116) in order to facilitate sending and receiving information in the form of synchronous or asynchronous voice communications, video, textual and/or encoded data to and from the mobile devices 102 and 104. This communication may be over a wireless signal on the cellular network of network 116 using applicable combinations and layers of telecommunications and networking protocols and standards such as 3G, HTTP and TCP/IP, etc.

Although the physical environment of the network 116 may have connected devices such as computers and mobile cellular devices, the physical environment may alternatively or additionally have or be described as comprising various digital devices such as personal digital assistants (PDAs), televisions, MP3 players, etc., software objects such as interfaces, Component Object Model (COM) objects and the like.

There are a variety of systems, components, and network configurations that may also support distributed computing environments within the network 116. For example, computing systems may be connected together within the network 116 by wired or wireless systems, by local networks or by widely distributed networks. Currently, many networks are coupled to the Internet, which provides an infrastructure for widely distributed computing and encompasses many different networks. Any such infrastructures, whether coupled to the Internet or not, may be used in conjunction with, be connected to, or comprise part of the network 116.

The mobile devices 102 and 104 can take the form of any of a large variety of mobile communications and/or processing devices having a handheld form factor. Examples of such may include cellular phones, personal digital assistants or PDAs (e.g., Blackberry® devices, iPhone® devices, Palm Pre® devices, Android® devices), cellular enabled laptop computers, netbook computers and tablet devices (e.g., IPAD® device).

Components of the computer/telecommunications network 116 that support, provide and/or facilitate communications devices on the computer/telecommunications network 116 may include those of a service provider. The service provider may be a cellular telephone service provider, landline telephone service provider, Internet service provider, Wi-Fi access service provider, cable service provider, satellite service provider, other data service provider, or a service provider providing any combination of such services, etc. Generally, the service provider charges subscribers for use of the services provided. In the example provided herein any one or more of mobile devices 102 and 104, vehicles 106 and 108, user computer 114 and server machine for facilitating electronic communication utilizing vehicle license plate numbers 112 may use or include devices belonging to or used by those who subscribe directly or indirectly to services provided by a service provider. Also, the functions performed by the mobile devices 102 and 104, vehicles 106 and 108, user computer 114 and/or server machine for facilitating electronic communication utilizing vehicle license plate numbers 112 may be performed by one or more systems connected to network 116 that individually perform and/or combine the functionalities of those systems described above.

The embodiments and applicable system components will be described in the general context of computer-executable instructions, such as program application modules, objects, or macros stored on computer- or processor-readable storage media and executed by a computer or processor. Those skilled in the relevant art will appreciate that the illustrated embodiments as well as other embodiments can be practiced with other system configurations and/or other computing system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network such as network 116. In a distributed computing environment, program modules may be located in both local and/or remote memory storage devices.

Overall, by the system 100 using a license plate number of a vehicle (e.g., vehicle 106), a user is able to post messages associated with that license plate number, that vehicle, or a driver of that vehicle such that the other driver and/or other users can respond to the post if they choose to do so. This can be accomplished anonymously through an online system on which registered users can publicly post and/or privately send comments, messages, compliments, warnings and/or other information associated with the license plate number of the vehicle of the other driver. The other driver may then access the online system and search the database of messages using their license plate number and selectively reply publicly, privately and/or anonymously to the registered user who had posted the information associated with the license plate number. The other driver may also select to receive automated notices when any messages are posted or sent associated with the other driver's or other selected license plate numbers.

The registered users may also select to send messages associated with a particular license plate number only to other registered users who have chosen to receive messages associated with the particular license plate number. In some embodiments, users may also select to opt out of the system posting public messages and/or sending private messages associated with their license plate number. In this instance, the user may be required to provide proof that they are the registered owner of the vehicle having the license plate number for which this “opt out” option is being selected. If desired, the users may also exchange personal contact information with each other.

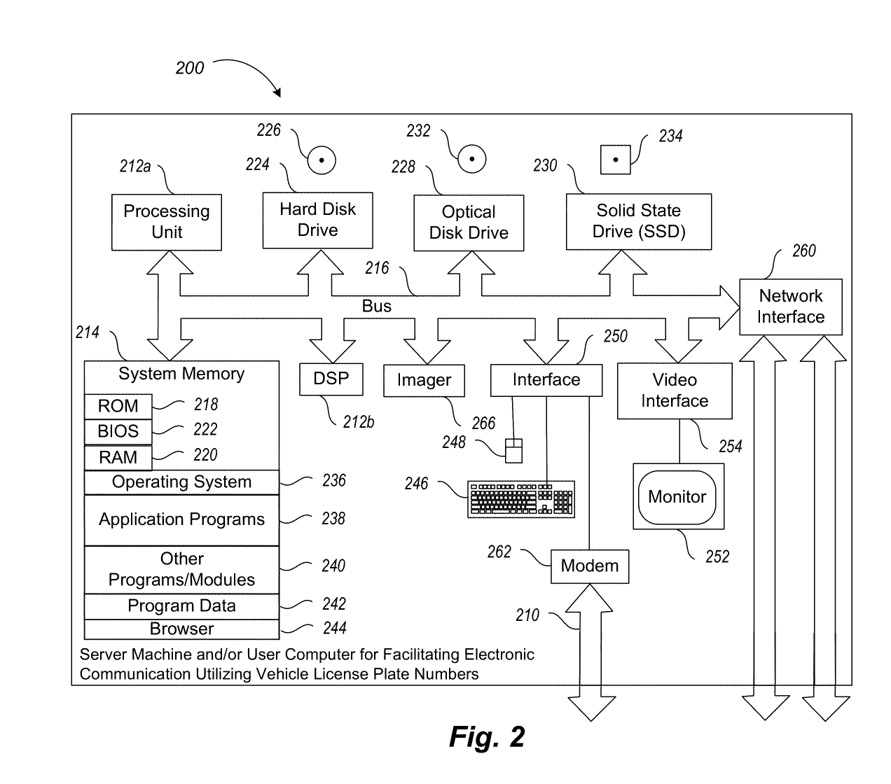

FIG. 2 is a schematic diagram of an example computer system 200 of the server machine for facilitating electronic communication utilizing vehicle license plate numbers 112. The computer system 200 is suitable for implementing systems, devices and methods for facilitating electronic communication utilizing vehicle license plate numbers, according to one illustrated embodiment. In some embodiments, some or all of the same, similar or equivalent structure and functionality of the computer system 200 shown in FIG. 2 and described herein may be that of, part of or operably connected to, the user computer 114 and/or a communication and/or computing system of vehicle 106 and/or vehicle 108 of FIG. 1. The computer system 200 will at times be referred to in the singular herein, but this is not intended to limit the embodiments to a single device since in typical embodiments, there may be more than one computer system or devices involved. Unless described otherwise, the construction and operation of the various blocks shown in FIG. 2 are of conventional design. As a result, such blocks need not be described in further detail herein, as they will be understood by those skilled in the relevant art.

The computer system 200 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSP) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the computer system 200, such as during start-up.

The computer system 200 may also include a plurality of interfaces such as network interface 260, interface 250 supporting modem 262 or any other wireless/wired interfaces.

The computer system 200 may include a hard disk drive 224 for reading from and writing to a hard disk 226, an optical disk drive 228 for reading from and writing to removable optical disks 232, and/or a solid state drive (SSD) 230 for reading from and writing to one or more non-removable or removable solid state memory devices 234 which include integrated circuit assemblies as memory to store data persistently. The optical disk 232 can be a DVD-RW, while the solid state memory device 234 may be a flash memory device, for example. The hard disk drive 224, optical disk drive 228 and SSD 230 may communicate with the processing unit 212 via the system bus 216. The hard disk drive 224, optical disk drive 228 and SSD 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program modules and other data for the computer system 200. Although the depicted computer system 200 is illustrated employing a hard disk 224, optical disk 228 and SSD 230, those skilled in the relevant art will appreciate that other types of computer-readable storage media that can store data accessible by a computer may be employed, such as magnetic cassettes, flash memory, digital video disks (“DVD”), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, digital versatile disks (DVD) or other optical disk storage, magnetic cassettes, magnetic tape or other magnetic storage devices, SSD, solid state memory or any other medium which can be used to store the desired information and which may be accessed by processing unit 212a.

Program modules can be stored in the system memory 214, such as an operating system 236, one or more application programs 238, other programs or modules 240 and program data 242. Application programs 238 may include instructions that cause the processor(s) 212 to facilitate electronic communication utilizing vehicle license plate numbers between various devices such as, for example, mobile devices 102 and 104, vehicle 106, vehicle 108, the one or more server machines for facilitating electronic communication utilizing vehicle license plate numbers 112 and user computer 114 of FIG. 1. In particular the program modules 240 may include modules that correspond to and/or, working in conjunction with the various hardware components of the computer system 200, implement the functions of one or more registration components, identification components, authentication components, communications components, association components, storage components, database searching components, etc., of the server machine for facilitating electronic communication utilizing vehicle license plate numbers, the user computer 114 and/or other device(s) of the system for facilitating electronic communication utilizing vehicle license plate numbers 100 of FIG. 1. For example, various program modules 240 may include instructions for handling security such as password or other access protection and communications encryption. The system memory 214 may also include communications programs, for example, a Web client, mobile device application or browser 244 for permitting the computer system 200 to access and exchange data with sources such as Web sites of the Internet, corporate intranets, extranets, or other networks and devices as described herein, as well as other server applications on server computing systems. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, Apple, and Microsoft of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the solid state memory device(s) 234 of the SSD 230.

An operator can enter commands and information into the computer system 200 through input devices such as a touch screen or keyboard 246 and/or a pointing device such as a mouse 248, and/or via a graphical user interface. Other input devices can include a microphone, joystick, game pad, tablet, scanner, digital camera, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The computer system 200 can include other output devices, such as speakers, printers, etc.

The computer system 200 can operate in a networked environment using logical connections to one or more remote computers and/or devices as described above with reference to FIG. 1. For example, the computer system 200 can operate in a networked environment using logical connections to one or more mobile devices, landline telephones, end user computers and other service providers or information servers. Communications may be via a wired and/or wireless network architecture, for instance, wired and wireless enterprise-wide computer networks, intranets, extranets, telecommunications networks, cellular networks, paging networks, and other mobile networks.

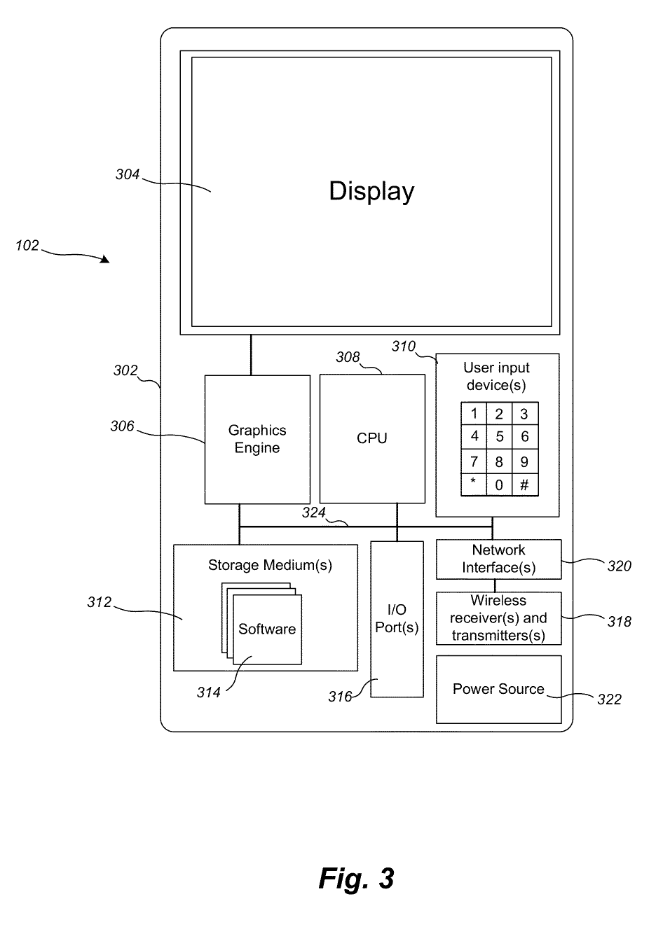

FIG. 3 shows the first mobile device 102 of FIG. 1 in more detail according to one example embodiment. The first mobile device 102 may have a housing 302, a display 304, a graphics engine 306, a central processing unit (CPU) 238, one or more user input devices 310, one or more storage mediums 312 having various software modules 314 stored thereon comprising instructions that are executable by the CPU 308, input/output (I/O) port(s) 316, one or more wireless receivers and transmitters 318, one or more network interfaces 320, and a power source 322. In some embodiments, some or all of the same, similar or equivalent structure and functionality of the first mobile device 102 shown in FIG. 3 and described herein may be that of, part of or operably connected to a communication and/or computing system of vehicle 106 and/or vehicle 108.

As previously noted, the first mobile device 102 may be any of a large variety of communications devices such as a cellular telephone, a smartphone, a portable media player (PMP), a personal digital assistant (PDA), a mobile communications device, a portable computer with built-in or add-on cellular communications, a portable game console, a global positioning system (GPS), a handheld industrial electronic device, or the like, or any combination thereof. The first mobile device 102 has at least one central processing unit (CPU) 308 which may be a scalar processor, a digital signal processor (DSP), a reduced instruction set (RISC) processor, or any other suitable processor. The central processing unit (CPU) 308, display 304, graphics engine 306, one or more user input devices 310, one or more storage mediums 312, input/output (I/O) port(s) 316, one or more wireless receivers and transmitters 318, and one or more network interfaces 320 may all be communicatively connected to each other via a system bus 324. The system bus 324 can employ any suitable bus structures or architectures, including a memory bus with memory controller, a peripheral bus, and/or a local bus.

The first mobile device 102 also includes one or more volatile and/or non-volatile storage medium(s) 312. The storage mediums 312 may be comprised of any single or suitable combination of various types of processor-readable storage media and may store instructions and data acted on by CPU 308. For example, a particular collection of software instructions comprising software 314 and/or firmware instructions comprising firmware are executed by CPU 308. The software or firmware instructions generally control many of the operations of the first mobile device 102 and a subset of the software and/or firmware instructions may perform functions to operatively configure hardware and other software in the first mobile device 102 to provide the initiation, control and maintenance of applicable computer network and telecommunication links from the first mobile device 102 to the server machine for facilitating electronic communication utilizing vehicle license plate numbers 112, another subscriber device such as second mobile device 104, vehicle 106, vehicle 108 and/or a user computer 114 via the network 116 as shown in FIG. 1 using the wireless receiver(s) and transmitter(s) 318, network interface(s) 320, and/or I/O ports 316.

By way of example, and not limitation, the storage medium(s) 312 may be processor-readable storage media which may comprise any combination of computer storage media including volatile and nonvolatile, removable and non-removable media implemented in any method or technology for storage of information such as computer readable instructions, data structures, program modules or other data. Combinations of any of the above should also be included within the scope of processor-readable storage media.

The storage medium(s) 312 may include system memory which includes computer storage media in the form of volatile and/or nonvolatile memory such as read-only memory (ROM) and random access memory (RAM). A basic input/output system (BIOS), containing the basic routines that help to transfer information between elements within first mobile device 102, such as during start-up or power-on, is typically stored in ROM. RAM typically contains data and/or program modules that are immediately accessible to and/or presently being operated on by CPU 308. By way of example, and not limitation, FIG. 3 illustrates software modules 314 including an operating system, application programs and other program modules that implement the processes and methods described herein.

The first mobile device 102 may also include other removable/non-removable, volatile/nonvolatile computer storage media drives. By way of example only, the storage medium(s) 312 may include a hard disk drive or solid state storage drive that reads from or writes to non-removable, nonvolatile media, a SSD that reads from or writes to a removable, nonvolatile SSD, and/or an optical disk drive that reads from or writes to a removable, nonvolatile optical disk such as a DVD-RW or other optical media. Other removable/non-removable, volatile/nonvolatile computer storage media that can be used in an operating environment of the first mobile device 102 include, but are not limited to, flash memory cards, other types of digital versatile disks (DVDs), micro-discs, digital video tape, solid state RAM, solid state ROM, and the like. The storage medium(s) are typically connected to the system bus 324 through a non-removable memory interface. The storage medium(s) 312 discussed above and illustrated in FIG. 3, provide storage of computer readable instructions, data structures, program modules and other data for the first mobile device 102. In FIG. 3, for example, a storage medium may store software 314 including an operating system, application programs, other program modules, and program data. The storage medium(s) 312 may implement a file system, a flat memory architecture, a database, or any other method or combination capable for storing such information.

A user may enter commands and information into the first mobile device 102 through touch screen display 304 or the one or more other input device(s) 310 such as a keypad, keyboard, camera, motion sensor, position sensor, light sensor, biometric data sensor, accelerometer, or a pointing device, commonly referred to as a mouse, trackball or touch pad. Other input devices of the first mobile device 102 may include a microphone, joystick, thumbstick, game pad, optical scanner, other sensors, or the like. These and other input devices are often connected to the CPU 308 through a user input interface that is coupled to the system bus 324, but may be connected by other interface and bus structures, such as a parallel port, serial port, wireless port, game port or a universal serial bus (USB). Generally, a unique software driver stored in software 314 configures each input mechanism to sense user input, and then the software driver provides data points that are acted on by CPU 308 under the direction of other software 314. The display is also connected to the system bus 324 via an interface, such as the graphics engine 306. In addition to the display 304, the first mobile device 102 may also include other peripheral output devices such as speakers, a printer, a projector, an external monitor, etc., which may be connected through one or more analog or digital I/O ports 316, network interface(s) 320 or wireless receiver(s) and transmitter(s) 318.

The first mobile device 102 may operate in a networked environment using connections to one or more remote computers or devices, such as a remote computer or device of the server machine for facilitating electronic communication utilizing vehicle license plate numbers 112, second mobile device 104, vehicle 106, vehicle 108, and/or user computer 114 within or connected to the computer network 116 of FIG. 1 and described above. The remote computer within or connected to network 116 may be a personal computer, a server, a router, a network PC, a peer device or other common network node, and typically includes many or all of the elements described above relative to the computer system 200 of FIG. 2. Such connections to the network 116 may include connections over cellular, satellite, local area network (LAN) connections or wide area network (WAN) connections as described above, and/or other networks.

When used in a LAN or WAN networking environment, the first mobile device 102 may be connected via the wireless receiver(s) and transmitter(s) 318 and network interface(s) 320, which may include, for example, cellular receiver(s) and transmitter(s), Wi-Fi receiver(s) and transmitter(s), and associated network interface(s). When used in a WAN networking environment, the first mobile device 102 may include a modem or other means as part of the network interface(s) for establishing communications over the WAN, such as the Internet. The wireless receiver(s) and transmitter(s) 318 and the network interface(s) 320 may be communicatively connected to the system bus 324. In a networked environment, program modules depicted relative to the first mobile device 102, or portions thereof, may be stored in a remote memory storage device of a remote system.

The first mobile device 102 has a collection of I/O ports 316 and/or short range wireless receiver(s) and transmitter(s) 318 and network interface(s) 320 for passing data over short distances to and from the first mobile device 102 or for coupling additional storage to the first mobile device 102. For example, serial ports, USB ports, Wi-Fi ports, Bluetooth® ports, IEEE 1394 (i.e., FireWire), and the like can communicatively couple the first mobile device 102 to other computing apparatuses. Compact Flash (CF) ports, Secure Digital (SD) ports, and the like can couple a memory device to the first mobile device 102 for reading and writing by the CPU 308 or couple the first mobile device 102 to other communications interfaces such as Wi-Fi or Bluetooth transmitters/receivers and/or network interfaces.

First mobile device 102 also has a power source 322 (e.g., a battery). The power source 322 may supply energy for all the components of the first mobile device 102 that require power when a traditional, wired or wireless power source is unavailable or otherwise not connected. Other various suitable system architectures and designs of the first mobile device 102 are contemplated and may be utilized which provide the same, similar or equivalent functionality as those described herein.

It should be understood that the various techniques, components and modules described herein may be implemented in connection with hardware, software and/or firmware or, where appropriate, with a combination of such. Thus, the methods and apparatus of the disclosure, or certain aspects or portions thereof, may take the form of program code (i.e., instructions) embodied in tangible media, such as various solid state memory devices, DVD-RW, RAM, hard drives, flash drives, or any other machine-readable or processor-readable storage medium wherein, when the program code is loaded into and executed by a machine, such as a processor of a computer, vehicle or mobile device, the machine becomes an apparatus for practicing various embodiments. In the case of program code execution on programmable computers, vehicles or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system including the example computer system 200 depicted in FIG. 2 and also in FIG. 3 of first mobile device 102. However, the program(s) can be implemented in assembly or machine language, if desired. In any case, the language may be a compiled or interpreted language, and combined with hardware implementations.

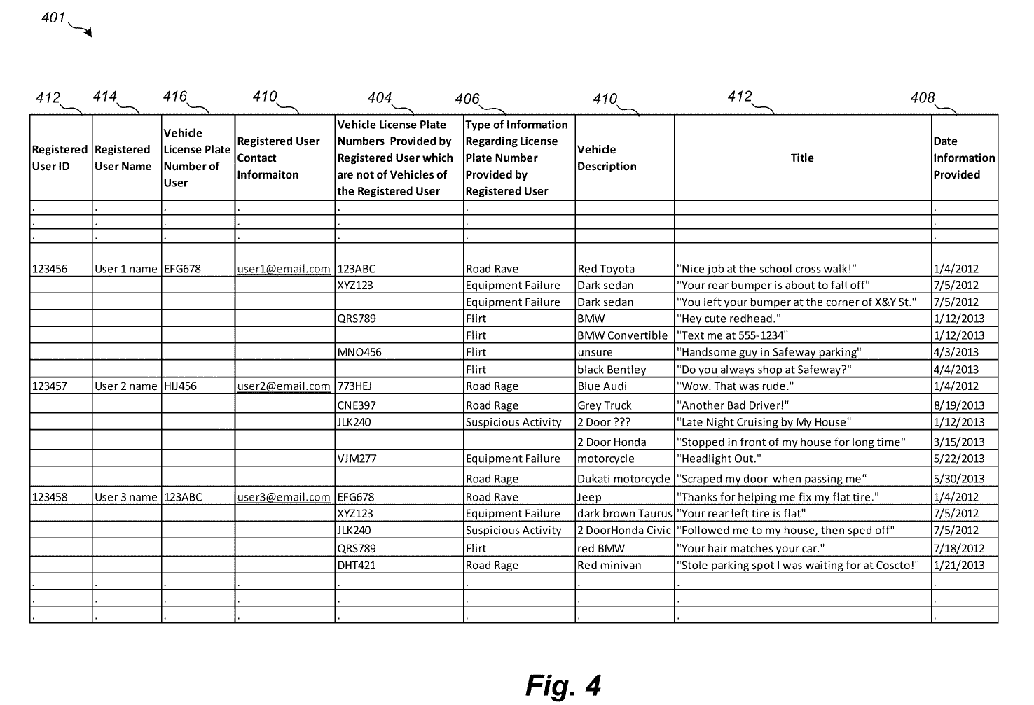

FIG. 4 is a diagram representing an example database schema 401 for facilitating electronic communication utilizing vehicle license plate numbers, according to one illustrated embodiment. For example, referring also to FIG. 1, in one embodiment a user may install a mobile device software application (i.e., an “app”) on their first mobile device 102 and/or install a software client on their user computer 114 available from the server machine for facilitating electronic communication utilizing vehicle license plate numbers 112 or other server. Alternatively, the user may access a web site via their first mobile device 102 or via their user computer 114 using a web browser or other client running on the first mobile device 102 or their user computer 114. The web site is provided or accessible by the server machine for facilitating electronic communication utilizing vehicle license plate numbers 112, or may be accessible by another server.

The mobile device app, software client and/or web site enables the user to input any vehicle license plate number 404 (e.g., a license plate number of vehicle 106) and provide information regarding the vehicle license plate number 406 such as a message, comment or other data regarding or otherwise pertaining to the license plate number 404 input by the user. The user may also provide a vehicle description 410 and a title 412 of the message, comment or other data. This vehicle license plate number 404 and/or the data regarding the license plate number 406 may be input, for example, via a voice command using a microphone input device, text input via a keyboard or keypad, or via an image of the license plate number (e.g., an image captured by a digital camera of the first mobile device 102 or other device, etc.). Various input devices and methods may be used, especially those that are convenient to use while in one's vehicle, while driving, while on the road, or otherwise shortly after observing another vehicle's license plate number. Such input devices may be part of, integrated with or in communication with one or more controls, buttons or other interface devices of the vehicle, such as those on the vehicle dashboard, touchscreen and/or steering wheel. For example, in one embodiment, a push-button feature may be provided on the user's vehicle dashboard and/or steering wheel that causes a message or post to be communicated regarding a particular license plate number that was input by the user via a voice command or from data captured from an image taken by a camera on or integrated with the vehicle, or by a camera on the user's mobile device that is in operable communication with the vehicle of the user. The push-button feature may also include taking of the image of the license plate number. For example, when the user presses the button or otherwise indicates that the user desires to send a message or make a post about a particular license plate number at which the camera is pointed, such as via a voice command, the system for facilitating electronic communication utilizing vehicle license plate numbers will send a signal to the camera to take a picture, will read the license plate number from the resulting image and will then send a message or make a post online regarding the license plate number. This process may also include a prompt for the user to record a voice message, the content of which may be (or may be part of) the substance of the message or post.

Also, a date 408 on which the data had been provided or a date otherwise associated with the information regarding the license plate number (e.g., a date the vehicle having the license plate number 404 was observed by the user) may be input or automatically captured by the first mobile device 102 or user computer 114 in conjunction with the vehicle license plate number 404 being input by the user. This date 408 may also be stored in the database and an association between the vehicle license plate number 404, the information regarding the vehicle license plate number 406 and the date 408 associated therewith may be generated and stored in or otherwise be accessible via accessing the database.

The license plate number 404 and the data regarding the license plate number 406 may be stored in a database of the system for facilitating electronic communication utilizing vehicle license plate numbers 100 having a database schema such as database schema 401, for example. Database schema 401 shows an example schema and sample data for one example embodiment. However, other database schemas, data structures and alternative arrangements of data may be utilized that store more, less or different data than that shown in the example database schema 401. Such a database may reside on the server machine for facilitating electronic communication utilizing vehicle license plate numbers 112, other database server, or on a device remote from, but accessible by the server machine for facilitating electronic communication utilizing vehicle license plate numbers 112. In some embodiments, some of or the entire database may temporarily or persistently reside locally on the mobile device, vehicle and/or user computer of the user who input the data or be otherwise distributed among a plurality of devices accessible by the server machine for facilitating electronic communication utilizing vehicle license plate numbers 112.

In some embodiments, the user first registers on the system for facilitating electronic communication utilizing vehicle license plate numbers 100 via the server machine for facilitating electronic communication utilizing vehicle license plate numbers 112 or other server. The registered user may have an associated registered user ID 408 generated for the mobile device app, software client and/or web site to allow the user to be authenticated and input the vehicle license plate number 404 and input the data regarding the license plate number 406. In this manner, an individual (e.g., the owner or driver of vehicle 106 having the license plate number that had been input by the registered user) may be enabled to respond to the registered user regarding the message or comment provided by the registered user without the registered user having to first reveal their personal contact information to the individual responding. For example, one may respond to the user who had provided the license plate number 404 and the data regarding the license plate number 406 by installing the mobile device app and/or software client, or visiting the web site on which the data regarding the license plate number 406 was posted and identify a particular posting of that registered user via a user interface of the mobile device app software client and/or web site (e.g., by clicking on or otherwise selecting the particular posting via the mobile device app software client and/or web site).

The system for facilitating electronic communication utilizing vehicle license plate numbers 100 will then provide a user interface in which the other user responding to the posting may input a message to the registered user who posted the information regarding the vehicle license plate number. The system 100 may access associated contact information 410 of the registered user via an identification number 412 associated with the identified particular posting of that registered user stored in the database of the system 100. This may be accomplished by the system 100 such that the registered user name 414 and other personal contact information of the registered user remains hidden or anonymous to the other user who is responding to the posting of the registered user. In addition to the vehicle license plate number 416 of the registered user, other information not shown in FIG. 4 regarding the registered user may also be stored in the database of the system 100, such as, for example, home address, age, personal profile information, other vehicle information, demographic information, etc. Some or all of such information may be selectively hidden from non-registered users, other registered users of the system and/or the general public. If the user responding to the posting of the registered user is also a registered user, the registered user may also likewise reply anonymously via the system for facilitating electronic communication utilizing vehicle license plate numbers 100 as described above. In some embodiments, the vehicle license plate number 416 of the registered user may be used as the registered user identification number 412.

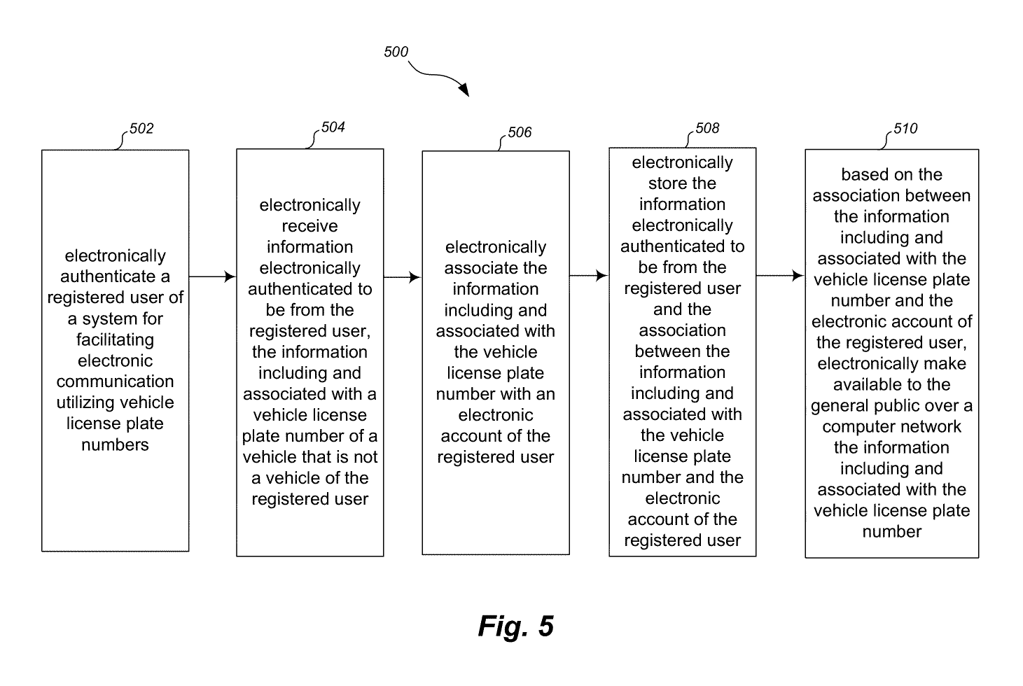

FIG. 5 is a flow diagram showing a method 500 of facilitating electronic communication utilizing vehicle license plate numbers, according to one illustrated embodiment.

At 502, the system for facilitating electronic communication utilizing vehicle license plate numbers 100 electronically authenticates a registered user of the system for facilitating electronic communication utilizing vehicle license plate numbers.

At 504, the system for facilitating electronic communication utilizing vehicle license plate numbers 100 electronically receives information electronically authenticated to be from the registered user, the information including and associated with a vehicle license plate number of a vehicle that is not a vehicle of the registered user.

At 506, the system for facilitating electronic communication utilizing vehicle license plate numbers 100 electronically associates the information including and associated with the vehicle license plate number with an electronic account of the registered user.

At 508, the system for facilitating electronic communication utilizing vehicle license plate numbers 100 electronically stores the information electronically authenticated to be from the registered user and the association between the information including and associated with the vehicle license plate number and the electronic account of the registered user.

At 510, the system for facilitating electronic communication utilizing vehicle license plate numbers 100, based on the association between the information including and associated with the vehicle license plate number and the electronic account of the registered user, electronically makes available to the general public over a computer network the information including and associated with the vehicle license plate number.

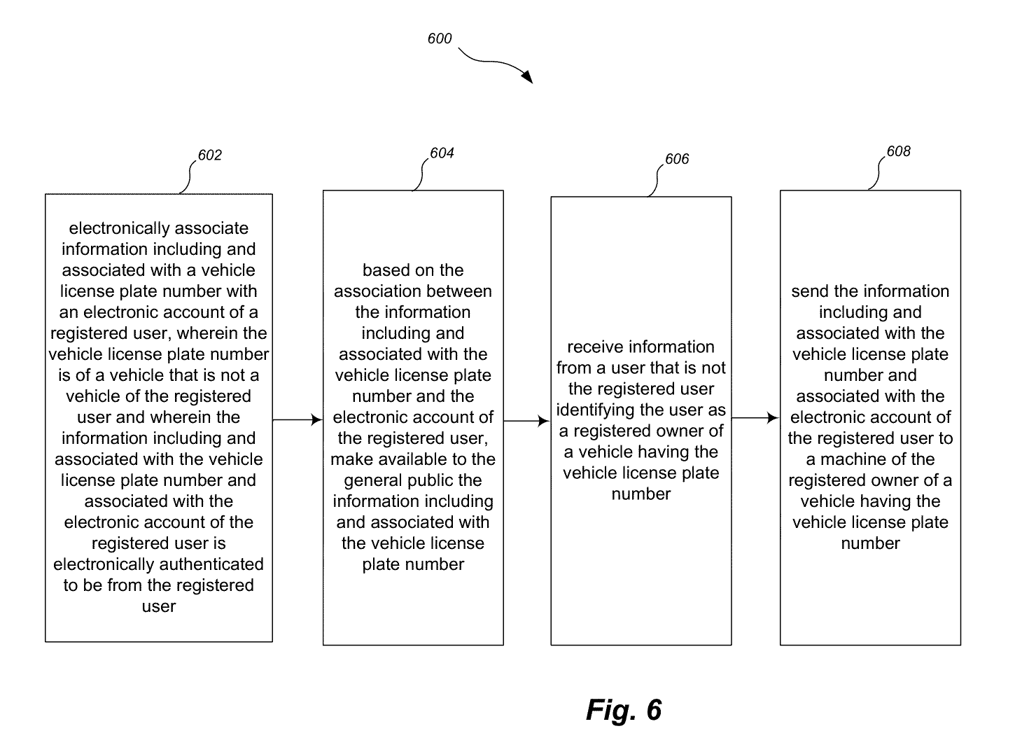

FIG. 6 is a flow diagram showing a method 600 of facilitating electronic communication utilizing vehicle license plate numbers including sending information associated with a vehicle license plate number to a machine of a registered owner of a vehicle, according to another illustrated embodiment.

At 602, the system for facilitating electronic communication utilizing vehicle license plate numbers 100 electronically associates information including and associated with a vehicle license plate number with an electronic account of a registered user. The vehicle license plate number is of a vehicle that is not a vehicle of the registered user. The information including and associated with the vehicle license plate number and associated with the electronic account of the registered user is electronically authenticated to be from the registered user.

At 604, the system for facilitating electronic communication utilizing vehicle license plate numbers 100, based on the association between the information including and associated with the vehicle license plate number and the electronic account of the registered user, makes available to the general public the information including and associated with the vehicle license plate number.

At 606, the system for facilitating electronic communication utilizing vehicle license plate numbers 100 receives information from a user that is not the registered user identifying the user as a registered owner of a vehicle having the vehicle license plate number.

At 608, the system for facilitating electronic communication utilizing vehicle license plate numbers 100 sends the information including and associated with the vehicle license plate number and associated with the electronic account of the registered user to a machine of the registered owner of a vehicle having the vehicle license plate number.

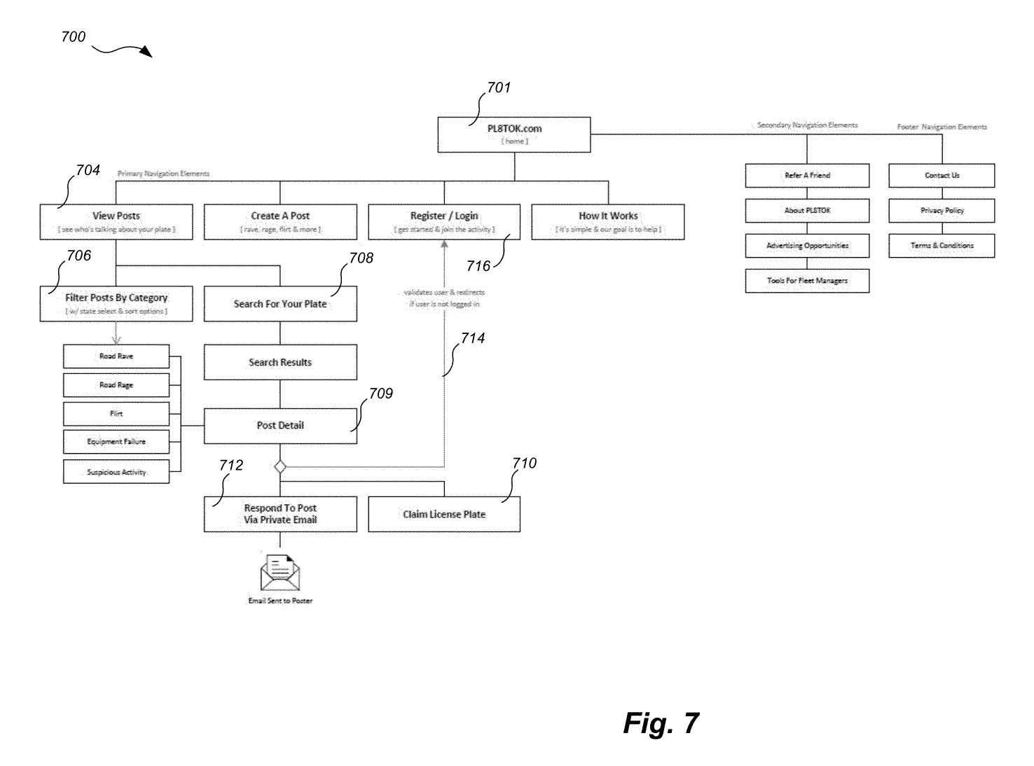

FIGS. 7-9 are user interface maps 700, 800 and 900 showing example architecture for user navigation of various portions of a user interface for facilitating electronic communication utilizing vehicle license plate numbers. Each box in the map represents a page or screen, or portion of a user interface to which the use may navigate from another page or screen represented by another box to which it is connected. For example, box 701 represents a “Home” interface portion from which the user may navigate via the user interface on the “Home” interface portion to a “View Posts” portion of the interface represented by box 704. From the “View Posts” portion represented by box 704, the user may navigate to various other portions of the user interface to view posts by other users, such as the “Filter Posts by Category” portion represented by box 706 or the “Search for Your Plate” screen represented by box 708 with which the user can input their own license plate number to see if there have been any posts regarding their license plate number. If a post of interest is found, the user may navigate to the “View Post Detail” user interface portion represented by box 709 to view the details of the post including the entire contents of the post and other related details. Box 710 represents a “Claim Your License Plate” portion of the user interface with which a user may indicate that a particular license plate associated with a post or message is that of the user's vehicle.

Box 712 represents a “Respond to Post Via Private Email” portion of the user interface with which a user may respond to a user privately via an email message. Other response options may also be available in other embodiments such as text, chat, and other forms of communication over social media. To respond to a user anonymously via an email message, the user may be required to be a registered user and may be redirected 714 via the user interface to log in or create a user account to do so from the “Respond to Post Via Private Email” portion of the user interface. Box 716 represents a “Register/Login” user interface portion. Also, the user may access the “Register/Login” user interface portion from the “Home” interface portion represented by box 701.

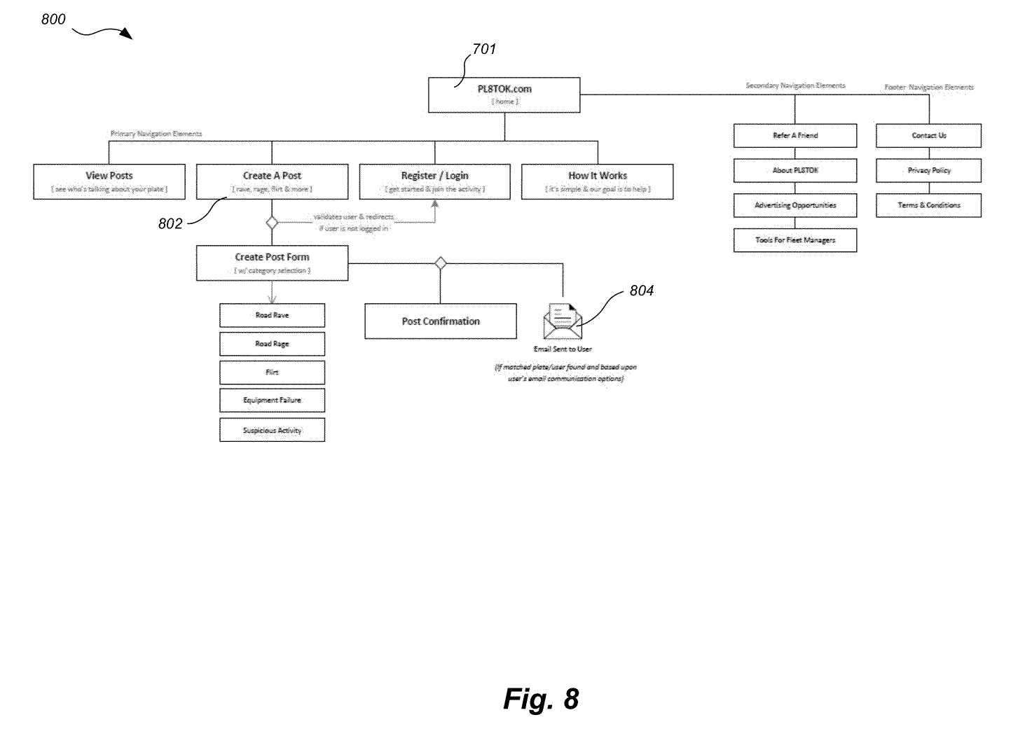

As shown in FIG. 8, box 802 represents a “Create a Post” portion of the user interface to which the user may navigate via the user interface from the “Home” screen represented by box 702 to create posts associated with license plate numbers of vehicles the user observes. As described above, the system for facilitating electronic communication utilizing vehicle license plate numbers may then send an email 804 or other message to the user associated with the license plate number if a match to a registered user is found in the system database. This may occur according to selectable email and communication options set by the user from which the message is being sent and/or the user to whom the message is being sent.

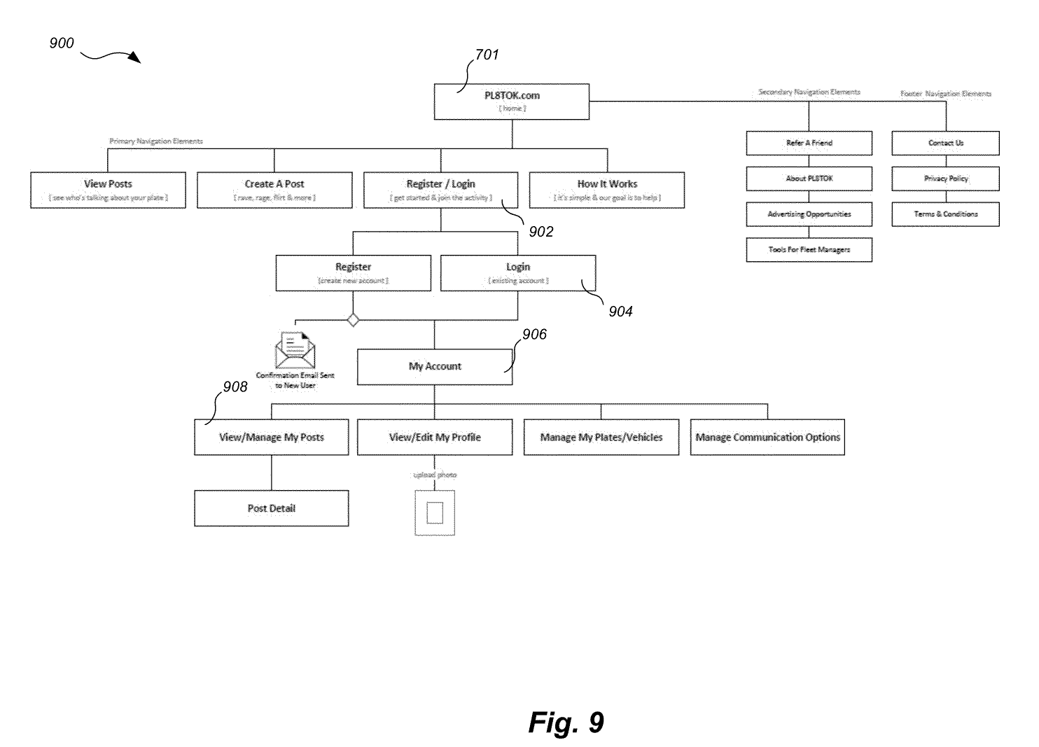

In FIG. 9, for example, box 902 represents a “Register” portion of the user interface to which the user may navigate via the user interface from the “Home” screen represented by box 702 to register with the system for facilitating electronic communication utilizing vehicle license plate numbers, such as by providing their license plate number and creating an account. Box 906 represents a “My Account” portion of the user interface to which the user may navigate via the user interface from the “Login” screen represented by box 904 after logging in to the system to access various information regarding their account, posts, license plates, account profile, communications settings and other account settings. Box 908 represents a “View/Manage My Posts” portion of the user interface to which the user may navigate via the user interface from the “My Account” user interface portion represented by box 906.

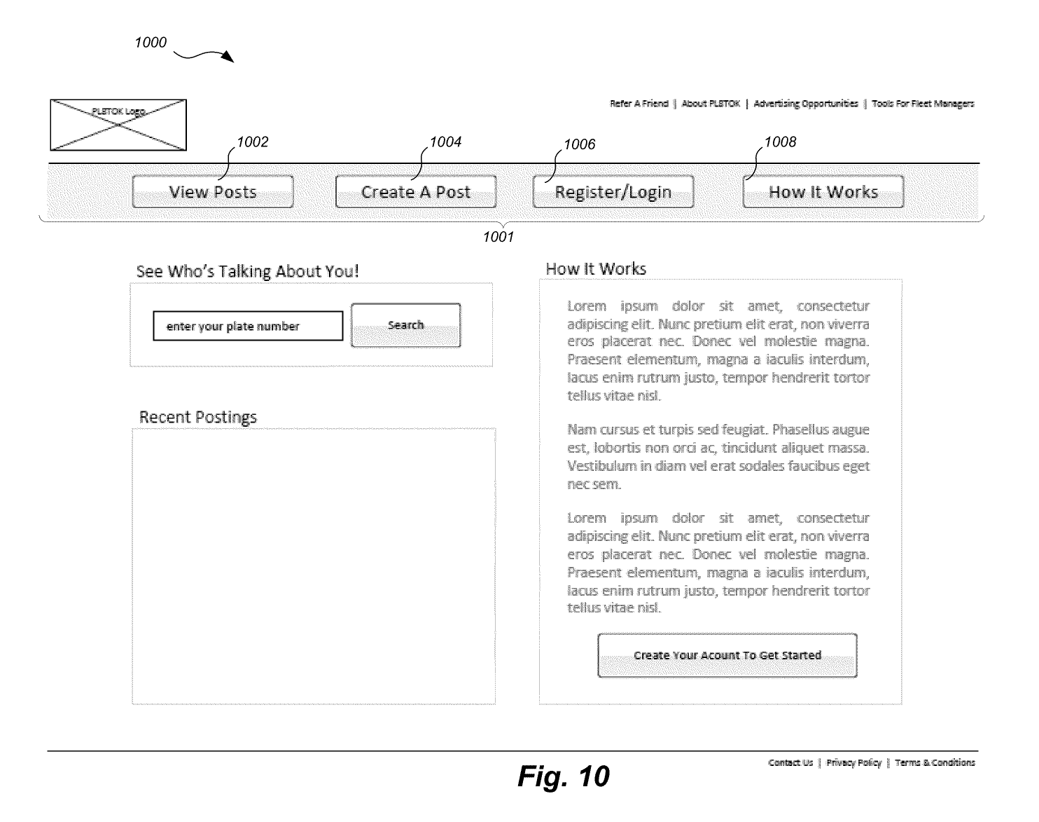

FIGS. 10-17 are wireframes representing example layouts and features of various example user interface portions of the system for facilitating electronic communication utilizing vehicle license plate numbers. For example, FIG. 10 is a wireframe representing an example layout and features of a “Home” user interface screen 1000 including a “Home” user interface portion 1001 from which the user may conveniently navigate to various other portions of the user interface for facilitating electronic communication utilizing vehicle license plate numbers. This “Home” user interface portion 1001 corresponds to box 702 in the user interface map shown in FIGS. 7-9. For example, the user may select a “View Posts” button 1002, a “Create A Post” button 1004, a “My Account” button 1006 and/or a “How it Works” button 1008 to navigate to the corresponding portions of the user interface of the system for facilitating electronic communication utilizing vehicle license plate numbers.

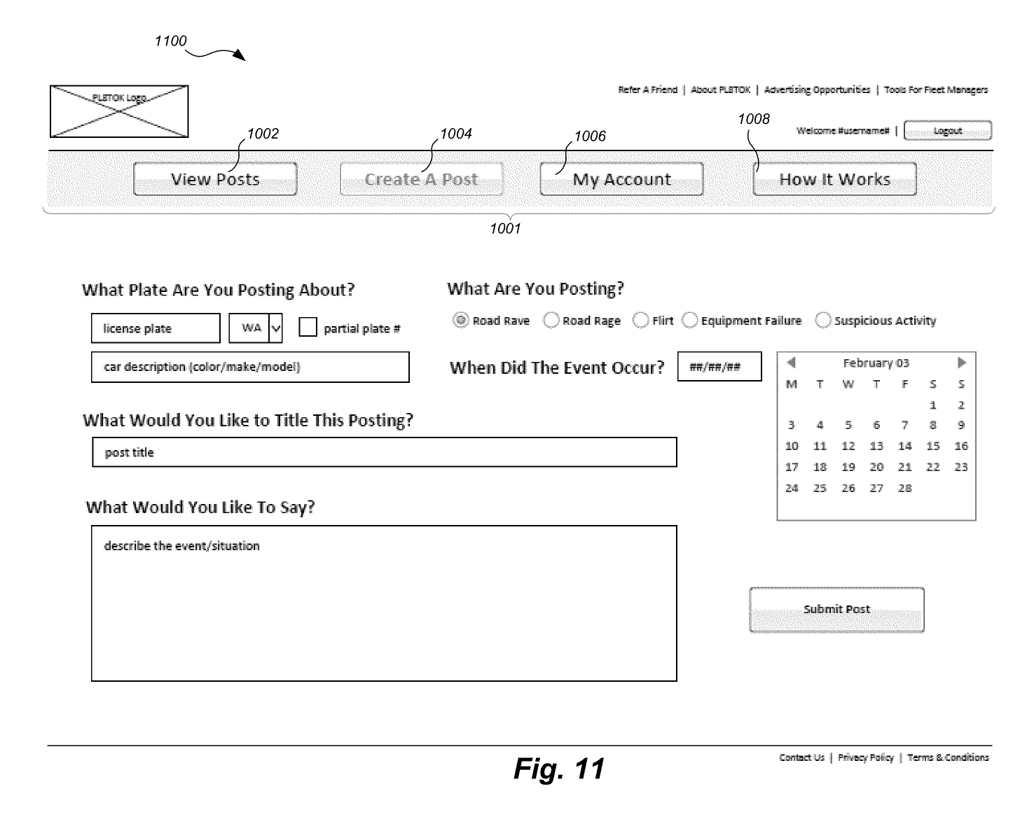

FIG. 11 is a wireframe representing an example layout and features of a “Create A Post” user interface portion 1100 for facilitating electronic communication utilizing vehicle license plate numbers. This “Create A Post” user interface screen 1100 corresponds to box 802 in the user interface map shown in FIG. 8. For example, the user may access the “Create A Post” user interface portion 1100 by selecting a “Create A Post” button 1004 on the “Home” portion 1001.

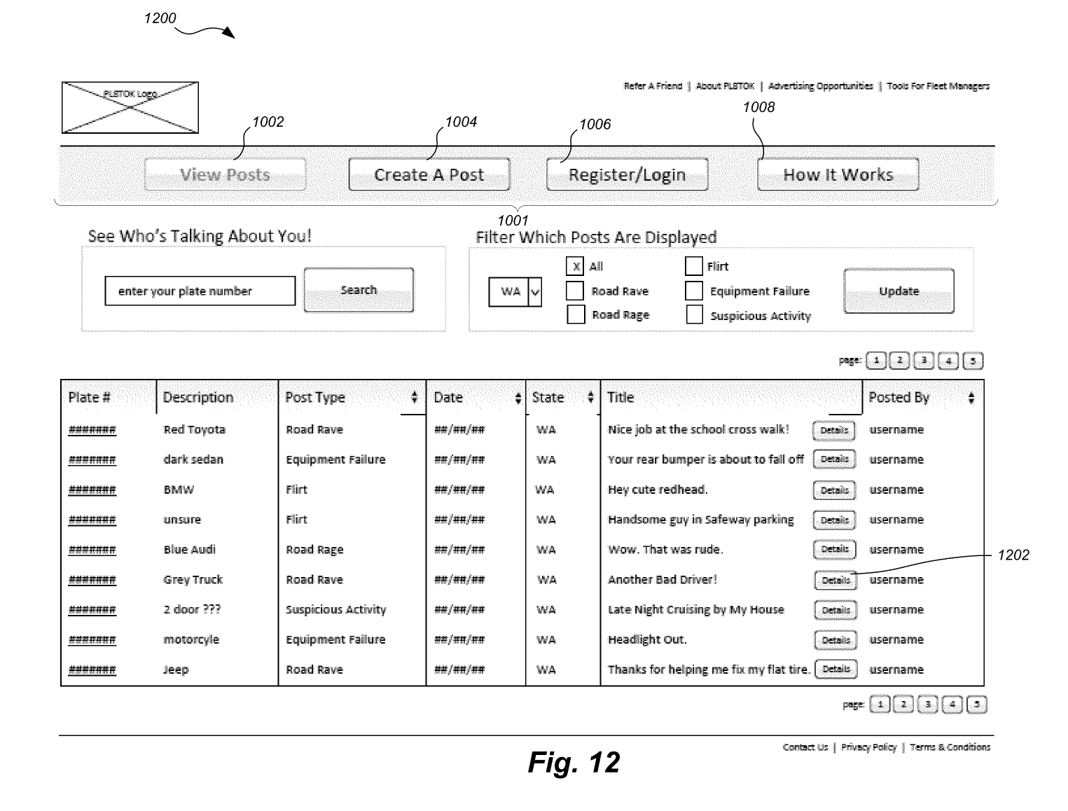

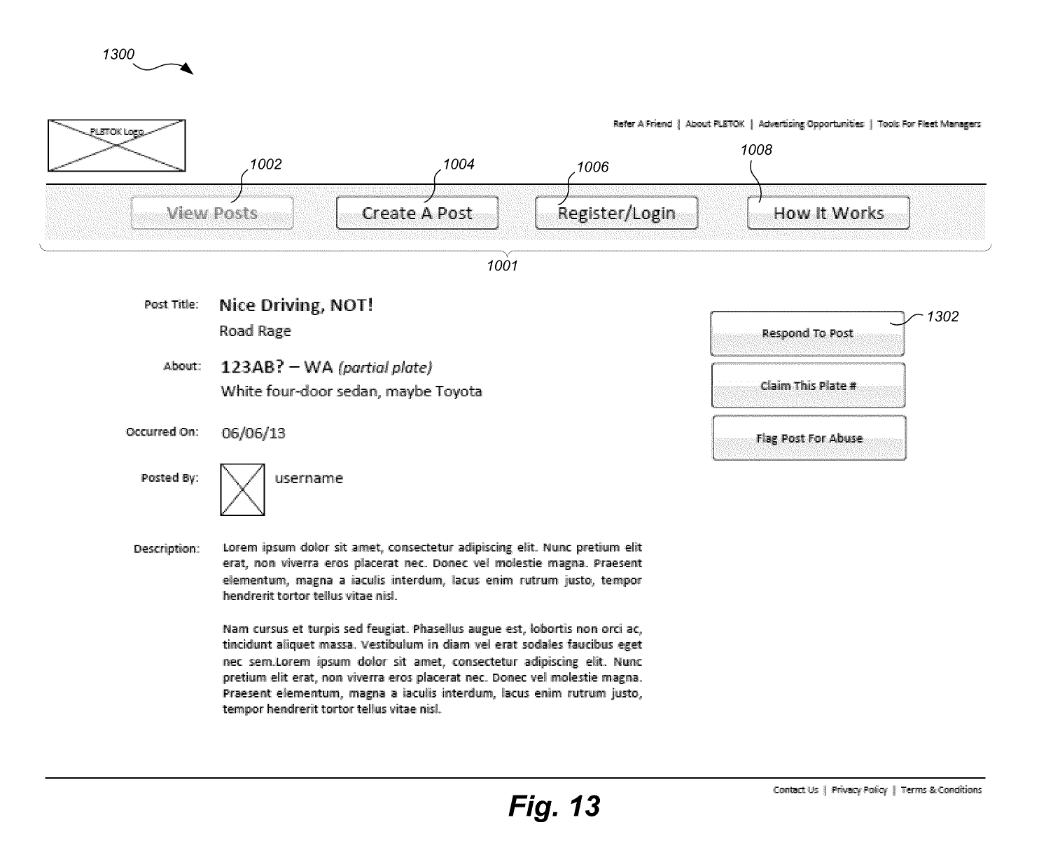

FIG. 12 is a wireframe representing an example layout and features of a “View Posts” user interface portion 1200 for facilitating electronic communication utilizing vehicle license plate numbers. This “View Posts” user interface portion 1200 corresponds to box 704 in the user interface map shown in FIG. 7. For example, the user may access the “View Posts” user interface portion 1200 by selecting a “View Posts” button 1002 on the “Home” portion 1001. The user may access the “View Post Detail” user interface portion 1300 (shown in FIG. 13) by selecting an applicable “details” button 1202 next to the applicable post in the a “View Posts” user interface portion 1200 shown in FIG. 12.

FIG. 13 is a wireframe representing an example layout and features of the “View Post Detail” user interface portion 1300. This “View Post Detail” user interface portion 1300 corresponds to box 709 in the user interface map shown in FIG. 7. For example, the user may access the “View Post Detail” user interface portion 1300 by selecting an applicable “details” button 1202 next to the applicable post in the a “View Posts” user interface portion 1200 shown in FIG. 12. The user may then access the “Respond to Post” user interface portion 1300 (shown in FIG. 13) by selecting an applicable “Respond to Post” button 1302 next in the “View Post Detail” user interface portion 1300.

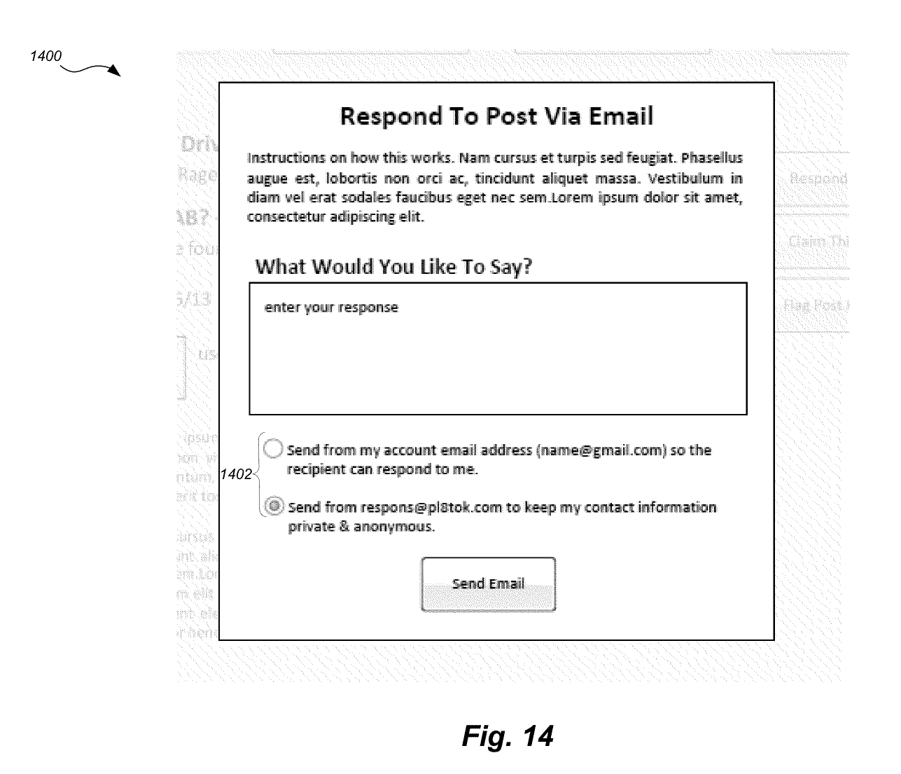

FIG. 14 is a wireframe representing an example layout and features of a “Respond to Post” user interface portion 1400. This “Respond to Post” user interface portion 1400 corresponds to box 712 in the user interface map shown in FIG. 7. For example, the user may access the “Respond to Post” user interface portion 1300 by selecting the applicable “Respond to Post” button 1302 in the “View Post Detail” user interface portion 1300 shown in FIG. 13. The user may then be provided with selectable user interface options 1402 in the Respond to Post” user interface portion 1400 to indicate a selection of whether to send an email from their personal email account or anonymously through the for facilitating electronic communication utilizing vehicle license plate numbers as described above.

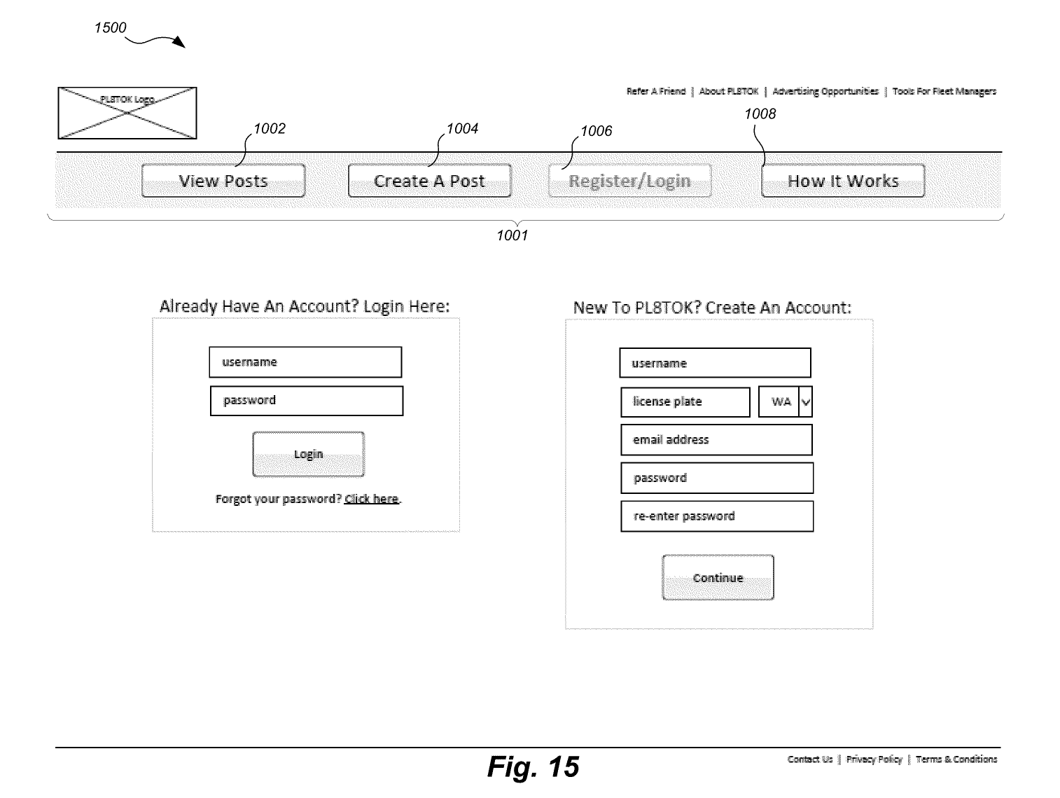

FIG. 15 is a wireframe representing an example layout and features of a “Register/Login” user interface portion 1500. This “Register/Login” user interface portion 1500 corresponds to box 716 in the user interface map shown in FIG. 7. For example, the user may access the “Register/Login” user interface portion 1300 by selecting the applicable “Register/Login” button 1006 in the “Home” user interface portion 1001. The user may then be provided with selectable user interface options 1402 to create a new account or login as an existing registered user as shown in FIG. 15.

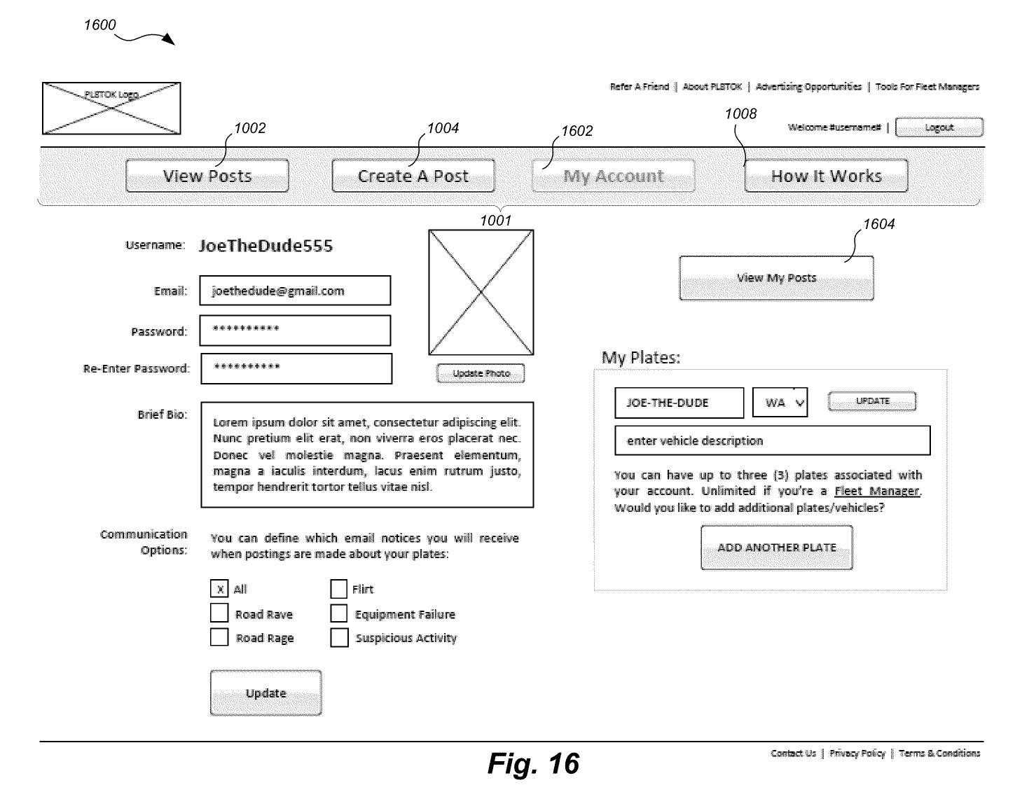

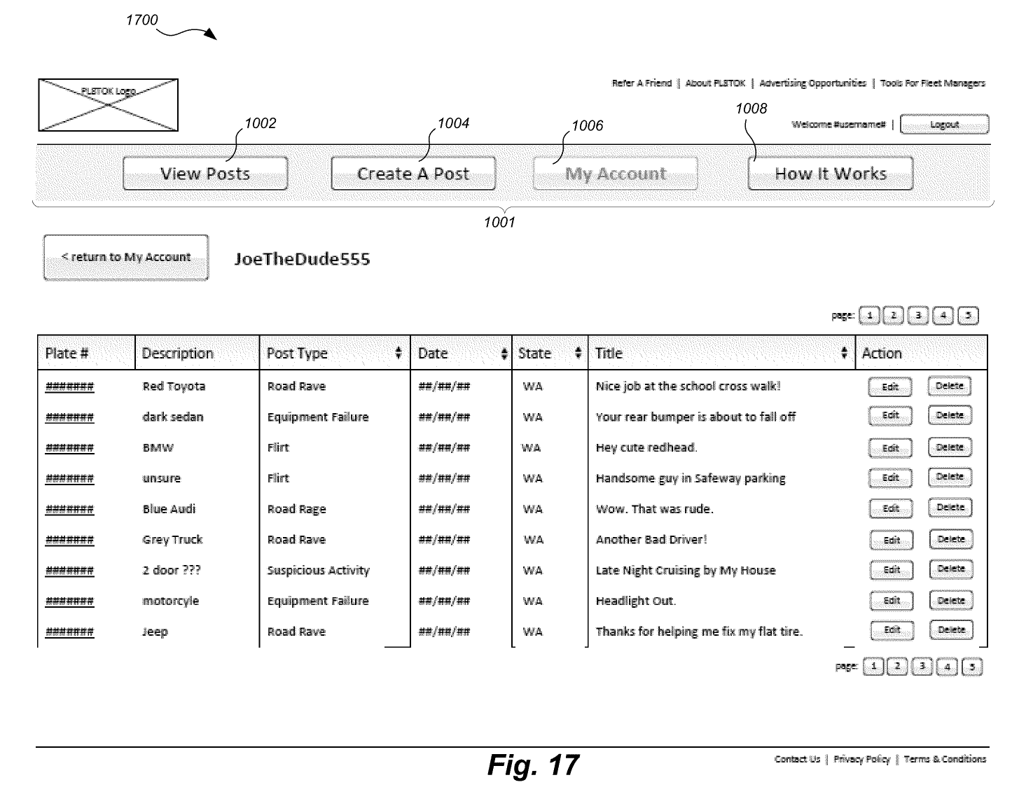

FIG. 16 is a wireframe representing an example layout and features of a “My Account” user interface portion 1600. This “My Account” user interface portion 1600 corresponds to box 906 in the user interface map shown in FIG. 9. For example, the user may access the “My Account” user interface portion 1300 by selecting the applicable “My Account” button 1602 in the “Home” user interface portion 1001 that is displayed after the user logs in. The user may then be provided with various selectable user interface options and account information as shown in the “My Account” user interface portion 1600 in FIG. 16 including, but not limited to information regarding the user's account, posts, license plates, account profile, communications settings and other account settings, etc. The user may also access the “Manage My Posts” user interface portion 1700 (shown in FIG. 17) by selecting the applicable “View My Posts” button 1604 in the “My Account” user interface portion 1600.

FIG. 17 is a wireframe representing an example layout and features of a “Manage My Posts” user interface portion 1700. This “Manage My Posts” user interface portion 1700 corresponds to box 906 in the user interface map shown in FIG. 9. For example, the user may access the “Manage My Posts” user interface portion 1700 by selecting the applicable “View My Posts” button 1604 in the “My Account” user interface portion 1600 shown in FIG. 16. The user may then be provided with a list of the posts they have made and options applicable thereto including, but not limited to, those shown in the “Manage My Posts” user interface portion 1700, including options to browse, edit, delete, view and sort posts.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary communication vehicles generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or various combinations thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as various combinations thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of non-transitory signal bearing media include, but are not limited to, the following: recordable type media such as floppy disks, hard disk drives, CD ROMs, digital tape, flash drives, solid state drives, and computer memory; and other non-transitory computer-readable storage media.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by at least one server machine for facilitating electronic communication utilizing vehicle license plate numbers, the method comprising:
electronically authenticating, by at least one authentication component of the at least one server machine for facilitating electronic communication utilizing vehicle license plate numbers, a registered user of a system for facilitating electronic communication utilizing vehicle license plate numbers, wherein the system for facilitating electronic communication utilizing vehicle license plate numbers is electronically accessible by the authentication component in order for the authentication component to perform the authentication electronically;
electronically receiving, by at least one communications component of the at least one server machine for facilitating electronic communication utilizing vehicle license plate numbers, information electronically authenticated to be from the registered user, the information including and associated with a vehicle license plate number of a vehicle that is not a vehicle of the registered user;
electronically associating, by at least one association component of the at least one server machine for facilitating electronic communication utilizing vehicle license plate numbers, the information including and associated with the vehicle license plate number with an electronic account of the registered user, the electronic account of the registered user electronically accessible by the at least one server machine for facilitating electronic communication utilizing vehicle license plate numbers in order for the at least one server machine for facilitating electronic communication utilizing vehicle license plate numbers to perform the associating electronically;
electronically storing, by at least one storage component of the system for facilitating electronic communication utilizing vehicle license plate numbers accessible by the at least one server machine for facilitating electronic communication utilizing vehicle license plate numbers, the information electronically authenticated to be from the registered user and the association between the information including and associated with the vehicle license plate number and the electronic account of the registered user; and
based on the association between the information including and associated with the vehicle license plate number and the electronic account of the registered user, the at least one communications component electronically making available to the general public over a computer network the information including and associated with the vehicle license plate number.

2. The method of claim 1 wherein the receiving, by at least one communications component of the at least one server machine for facilitating electronic communication utilizing vehicle license plate numbers, information electronically authenticated to be from the registered user includes receiving the information electronically authenticated to be from the registered user from a remote machine of the registered user.

3. The method of claim 1 wherein the information electronically authenticated to be from the registered user includes information regarding driving behavior of a driver of the vehicle that is not a vehicle of the registered user.

4. The method of claim 1 wherein the information electronically authenticated to be from the registered user includes information regarding a complaint regarding driving behavior of a driver of the vehicle that is not a vehicle of the registered user.

5. The method of claim 1 wherein the information electronically authenticated to be from the registered user includes information regarding a compliment regarding a driver of the vehicle that is not a vehicle of the registered user.

6. The method of claim 1 wherein the information electronically authenticated to be from the registered user includes a message from the registered user to a driver of the vehicle that is not a vehicle of the registered user, the message associated with and identifiable by the vehicle license plate number.

7. The method of claim 1 further comprising:
sending, by at least one communications component of the at least one server machine for facilitating electronic communication utilizing vehicle license plate numbers, the information to a machine of a user associated with the vehicle license plate number based on the vehicle license plate number.

8. The method of claim 7 further comprising:
before the sending, electronically identifying via the license plate number, by at least one identification component of the at least one server machine for facilitating electronic communication utilizing vehicle license plate numbers, the user associated with the vehicle license plate number.

9. The method of claim 8 wherein the user associated with the vehicle license plate number is one of a plurality of registered users of the system for facilitating electronic communication utilizing vehicle license plate numbers.

10. The method of claim 8 wherein the identifying includes electronically searching, by at least one database searching component of the at least one server machine for facilitating electronic communication utilizing vehicle license plate numbers, a database of vehicle license plate numbers to find the vehicle license plate number of the user associated with the vehicle license plate number, the database of vehicle license plate numbers accessible by the searching component in order for the searching component to perform the searching of the database of vehicle license plate numbers.

11. The method of claim 10 wherein the database of vehicle license plate numbers includes:
an electronically stored relationship between an account of the registered user and the license plate number of the registered user; and
a one to many relationship between the account of the registered user and license plate numbers of vehicles that are not vehicles of the registered user based on information electronically authenticated to be from one or more registered users.

12. The method of claim 1, further comprising:
electronically receiving, by at least one communications component of the at least one server machine for facilitating electronic communication utilizing vehicle license plate numbers, information from a user that is a registered owner of the vehicle having the license plate number that is not the vehicle of the registered user; and
associating the registered owner of the vehicle that is not the vehicle of the registered user with a license plate number of the registered owner of the vehicle.

13. The method of claim 12, further comprising:
based on the electronically receiving the information from a user that is the registered owner of the vehicle having the license plate number that is not the vehicle of the registered user, identifying the registered user, by the at least one identification component of the at least one server machine for facilitating electronic communication utilizing vehicle license plate numbers, based on the association between the information including and associated with the vehicle license plate number and the electronic account of the registered user; and
sending a notification to the registered user, by the at least one communications component of the at least one server machine for facilitating electronic communication utilizing vehicle license plate numbers, that the user who is the registered owner of the vehicle having the license plate number has responded with a response to the electronically making available to the general public the information including and associated with the vehicle license plate number.

14. The method of claim 13, further comprising:
based on the electronically received information from the user that is the registered owner of the vehicle having the license plate number that is not the vehicle of the registered user, registering on the system for facilitating electronic communication utilizing vehicle license plate numbers, by a registration component of the at least one server machine for facilitating electronic communication utilizing vehicle license plate numbers, the user who is the registered owner of the vehicle having the license plate number, wherein the registering includes:
generating, by a registration component of the at least one server machine for facilitating electronic communication utilizing vehicle license plate numbers, a user account for the user that is the registered owner of the vehicle; and
associating, by at least one association component of the at least one server machine for facilitating electronic communication utilizing vehicle license plate numbers, the generated user account with the vehicle license plate number.

15. The method of claim 12, further comprising:
before the electronically receiving information from the user that is the registered owner of the vehicle having the license plate number that is not the vehicle of the registered user, electronically making available to the general public, by the at least one communications component of the at least one server machine for facilitating electronic communication utilizing vehicle license plate numbers, an electronically generated user interface to respond to the electronically making available to the general public the information including and associated with the vehicle license plate number; and
based on the license plate number, associating, by at least one association component of the at least one server machine for facilitating electronic communication utilizing vehicle license plate numbers, the response from the registered owner of the vehicle having the license plate number with the electronically making available to the general public the information including and associated with the vehicle license plate number.

16. The method of claim 15, further comprising:
in response to the electronically receiving the information from the user that is the registered owner of the vehicle, searching based on the license plate number in an electronic database, by at least one database searching component of the at least one server machine for facilitating electronic communication utilizing vehicle license plate numbers, to find an account of the registered user of the system for facilitating electronic communication utilizing vehicle license plate numbers that is electronically associated with the information including and associated with the vehicle license plate number made available to the general public; and
in response to the searching, communicating based on the license plate number, by at least one communications component of the at least one server machine for facilitating electronic communication utilizing vehicle license plate numbers, at least some of the information from the user that is the registered owner of the vehicle to a machine of the registered user of the system for facilitating electronic communication utilizing vehicle license plate numbers, such that the at least some of the information identifies to the registered user, solely by the vehicle license plate number included in and associated with the information made available to the general public, the user that is the registered owner of the vehicle having the vehicle license plate number.

17. The method of claim 1 wherein the information including and associated with the vehicle license plate number that is electronically made available to the general public by the at least one communications component includes one or more of: information regarding a vehicle having the vehicle license plate number, information regarding a driver of a vehicle having the vehicle license plate number, information regarding an owner of a vehicle having the vehicle license plate number, a complaint regarding driving behavior of a driver of a vehicle having the vehicle license plate number, a compliment regarding a driver of the vehicle having the vehicle license plate number, a request to contact a driver of the vehicle having the vehicle license plate number, suspicious activity of a driver of the vehicle having the vehicle license plate number, an equipment failure regarding a vehicle having the vehicle license plate number, an advertisement regarding a vehicle having the vehicle license plate number, contact information regarding a driver of a vehicle having the vehicle license plate number, contact information regarding an owner of a vehicle having the vehicle license plate number, an accident regarding a vehicle having the vehicle license plate number and an emergency regarding the vehicle having the vehicle license plate number.

18. The method of claim 1 wherein the electronically receiving, by at least one communications component of the at least one server machine for facilitating electronic communication utilizing vehicle license plate numbers, the information including and associated with a vehicle license plate number of a vehicle that is not a vehicle of the registered user includes electronically receiving the information including and associated with the vehicle license plate number of the vehicle, from one or more of: a mobile device of the registered user of the system for facilitating electronic communication utilizing vehicle license plate numbers, a vehicle of the registered user of the system for facilitating electronic communication utilizing vehicle license plate numbers and a computer of the registered user of the system for facilitating electronic communication utilizing vehicle license plate numbers.

19. A system for facilitating electronic communication utilizing vehicle license plate numbers comprising:
at least one authentication component of at least one server machine that electronically authenticates a registered user of the system for facilitating electronic communication utilizing vehicle license plate numbers;
at least one communications component of the at least one server machine that electronically receives information electronically authenticated to be from the registered user, the information including and associated with a vehicle license plate number of a vehicle that is not a vehicle of the registered user of the system;
at least one association component of the at least one server machine that electronically associates the information including and associated with the vehicle license plate number with an electronic account of the registered user;
at least one storage component accessible by the at least one server machine that electronically stores the information electronically authenticated to be from the registered user and the association between the information including and associated with the vehicle license plate number and the electronic account of the registered user; and
at least one communications machine that, based on the association between the information including and associated with the vehicle license plate number and the electronic account of the registered user, makes available to the general public the information including and associated with the vehicle license plate number.

20. The system of claim 19 wherein the at least one communications component of the at least one server machine for facilitating electronic communication utilizing vehicle license plate numbers sends, based on the vehicle license plate number, the information to a machine of a user associated with the vehicle license plate number.

21. The system of claim 7 further comprising at least one identification component of the at least one server machine for facilitating electronic communication utilizing vehicle license plate numbers that electronically identifies, via the vehicle license plate number, the user associated with the vehicle license plate number before the at least one communications component of the at least one server machine sends the information to the machine of the user associated with the vehicle license plate number.

22. At least one non-transitory computer-readable storage medium having computer-executable instructions stored thereon that, when executed by at least one computer system, causes the at least one computer system to perform:
electronically associating information including and associated with a vehicle license plate number with an electronic account of a registered user, wherein the vehicle license plate number is of a vehicle that is not a vehicle of the registered user and wherein the information including and associated with the vehicle license plate number and associated with the electronic account of the registered user is electronically authenticated to be from the registered user;
based on the association between the information including and associated with the vehicle license plate number and the electronic account of the registered user, making available to the general public the information including and associated with the vehicle license plate number;
receiving information from a user that is not the registered user identifying the user as a registered owner of a vehicle having the vehicle license plate number; and
sending the information including and associated with the vehicle license plate number and associated with the electronic account of the registered user to a machine of the registered owner of a vehicle having the vehicle license plate number.

23. The at least one non-transitory computer-readable storage medium of claim 22 wherein the information including and associated with the vehicle license plate number that is electronically made available to the general public includes one or more of: information regarding a vehicle having the vehicle license plate number, information regarding a driver of a vehicle having the vehicle license plate number, information regarding an owner of a vehicle having the vehicle license plate number, a complaint regarding driving behavior of a driver of a vehicle having the vehicle license plate number, a compliment regarding a driver of the vehicle having the vehicle license plate number, a request to contact a driver of the vehicle having the vehicle license plate number, suspicious activity of a driver of the vehicle having the vehicle license plate number, an equipment failure regarding a vehicle having the vehicle license plate number, an advertisement regarding a vehicle having the vehicle license plate number, contact information regarding a driver of a vehicle having the vehicle license plate number, contact information regarding an owner of a vehicle having the vehicle license plate number, an accident regarding a vehicle having the vehicle license plate number and an emergency regarding the vehicle having the vehicle license plate number.

24. The at least one non-transitory computer-readable storage medium of claim 22 wherein the information electronically authenticated to be from the registered user includes a message from the registered user to a driver of the vehicle that is not a vehicle of the registered user, the message associated with and identifiable by the vehicle license plate number.
